(19) United States
(12) Patent Application Publication
(10) Pub. No.: US 2009/0038283 A1
(43) Pub. Date: Feb. 12, 2009

(54) Combination blower, edger and trimmer and method for tending vegetation

(76) Inventor: Edward P. Hurley, Sarasota, FL (US)

Correspondence Address: CHARLES J. PRESCOTT, P.A., SUITE 115, 2033 WOOD STREET, SARASOTA, FL, 34237, US

(21) Appl. No.: 11/890,910

(22) Filed: Aug. 8, 2007

(51) Int. Cl. A01D 34/416; A01D 34/00

(52) U.S. Cl. 56/12.7; 56/12.8

(57) ABSTRACT

A combined edger, trimmer and blower generally referred to as a lawn care apparatus for tending vegetation. More particularly, a novel handlebar provides a power control handle to maintain a boom on a longitudinal line of symmetry from a fixed point to an upright motor assembly in response to a side control handle rotating and translating the boom from a gearbox to a tangential tool assembly in front of an operator on a lateral line of symmetry. The gearbox including one or more lateral hubs that quick couples the side control handle into either a right or left handed holding position when the fixed point is to the side of an operator. The gearbox further containing one or more orthogonal gears with one or more gear addendum cams to lock the tangential tool assembly into a vertical or horizontal operating position, that is, a narrow or wide operating framework.

### CROSS REFERENCE TO RELATED APPLICATIONS

Not Applicable.

### STATEMENT REGARDING FEDERALLY SPONSORED RESEARCH OR DEVELOPMENT

Not Applicable.

### DESCRIPTION OF ATTACHED APPENDIX

Not Applicable.

### BACKGROUND OF THE INVENTION

This invention relates generally to the field of lawn care and more specifically to a COMBINATION BLOWER, EDGER AND TRIMMER AND METHOD FOR TENDING VEGETATION.

Complete lawn care includes trimming areas that lawn equipment operators cannot access easily with heavier mowers; such as, operating handheld power tools along defined lawn perimeter routes (i.e., sidewalks, driveways, patios and landscape beds) to edge vegetation where blowers can readily disperse unwanted vegetation debris (i.e., lawn clippings or fallen leaves) back into interior lawns where vegetation debris is atypically seen; and trimming vegetation along interior lawn routes (i.e., around trees, fence lines and other property improvements) where blowers are not operated. Carrying out separate lawn trimming tasks has traditionally required different and separate lawn tools, namely, a string trimmer, a stick edger, a blower or a combination of such devices could fatigue an operator when power tools tend to interfere with each other. For instance, a grounds keeper may carry, transport and operate a string trimmer, leading the operator far within the interior of a lawn without the need of additional fast moving heated blower parts to the operation. Lawn rhizomes can grow vigorously onto sidewalks, into sand traps and over other firm ground surfaces for long periods of time before being edged and dispersed into lawns which may not require another operating tool. Providing similar balance and power with an all-in-one edger, trimmer and blower tool can justify the need for combining individual lawn tools together on a convenient lawn care linked route.

Efforts have been taken to combine lawn care operation along lawn care routes. For example, U.S. Pat. No. 4,773,471 discloses separate operating heads, such as a string trimmer head or a blower head that can be attached and detached from the same power plant and drive train, saving the expense of a second motor. This system requires that a significant subassembly of the tool be removed and replaced by another tool, requiring the worker to carry separate tools and to change operating heads on the tool which significantly lengthens the lawn care route.

U.S. Patent Application Publication Number US 2002/0007559 discloses a string trimmer with a specially designed shroud that is supposed to help the rotating string of the string trimmer to function as a blower. While it has long been known that the rotating string of the string trimmer provides some blowing forces, they tend to be spread out 360° degrees and even this reference discloses debris deflecting in line with the operator, which provides little benefit in concentrated airflow, noise isolation and debris removal from sidewalks and so forth. The primary shortcoming of this invention is that the rotary operation could become messy with potentially dangerous flying material and the operable blower system has cooling qualities far removed from inner sensitive plastic components.

U.S. Pat. No. 6,460,253 B1 discloses a lawn apparatus that can be converted from a string trimmer into a bi-rotary blade cutter and that it can be modified to attach a blower flute or scroll to direct air flow generated by a cooling fan which is part of the string trimmer spool and designed to cool the motor of the apparatus. Motor housings designed to trap in heat and vacuum in debris near tool assemblies could start on fire similar to when dryer vents catch on fire from built up lint. When combining lawn tools into this invention, airfoil blades can rapidly swing back and forth with the string trimmer line which can build up heat from friction and melt the string line or the airfoils can loosen and fly off towards bystanders. The motor and tool combined weight at the tool load end is not ideally positioned for the operator to carry or balance a load near an operator's vertical axis. Furthermore, the sharp airfoil blades can shred the more elastic string line when the airfoil blades create lift to bend the more sensitive string line. This invention further discloses exposed bidirectional parts like springs that can hold debris in and lock the blades into an open position at all times. During lawn growing seasons, lawn heights can grow between 4 to 10 inches putting this invention at a disadvantage for lawn edging with an electric motor because the required thin string line filament can melt faster than long and thick string line filament; especially when motors are not designed to cut taller turfgrass like St. Augustine grass. There is a closed flue at the top of the motor that doesn't allow heat to rise naturally and a similar devise may have just been recalled on July 2007 for heat related problems.

Another example of a multi-purpose lawn tool is disclosed in U.S. Pat. No. 7,047,592 B2 and U.S. Provisional Pat. No. 60/696,738 whereby the trimmer/blower is described as an inoperable blower when the string trimmer head and impeller is made operable. Accordingly, the operable string trimmer head and inoperable blower provides an air inlet cover to pull in hot gases inside the large vertical blower by an operable impeller with notches which in turn could cause sensitive string line filament to seize or melt. This invention further describes a closed air inlet cover, that is, a closed chimney when the string trimmer head is made operable which prevents hot gases from naturally rising. In addition, the operable string trimmer head consists of a hub assembly for holding in debris which can grind into smaller particles and wear out sensitive exposed blower material; especially when impeller notches are used to vacuum debris upward into the blower from a lawn surface. The string trimmer head and impeller are made operable along a lawn interior trimming route known not only for gathering mower clippings, but also trimmer clippings in close proximity of the inoperable blower and operable vacuum. Hot air pressure can warp the movable blower housing possibly causing loud noises by the constantly rotating impeller which could disturb the operator and bystanders. The invention clearly shows that the impeller is not designed for vertical equilibrium as the impeller hovers over the string trimmer. Operating alongside a corresponding edging route will make this bent shaft illustrated invention more uncomfortable to operate. Another drawback to the invention is the impeller is not made silent during trimming operation. Accordingly, an air inlet cover that shuts off the operable blower function of a constantly rotating impeller requires more energy to operate and is wasteful on fuel. The air inlet cover, hand lever and other surplus weight of this invention is heavier than typical lawn power tool sources. Consequently, the weight distribution at the tool end requires the motor to be heavier than typical lawn tool power sources which either throws the invention out of balance or creates more weight at the motor end. It can only take a moment to go from lawn edging to lawn trimming to normal-duty or heavy-duty blowing operation, that is, 256 different lawn care combinations make this invention impractical to operate because of having to remove a harness followed by setting the tool down on the ground, turning the motor off, having to move a long distance to the tool assembly to activate the tool assembly and continued by twice the effort to crank the motor back on for tending vegetation. When the accessory cutting guard is attached to this invention the rotating string will be significantly exposed to the side of an operator which is not as safe as having a cutting guard aligned with a lawn edge in front of an operator at all times. It would be more affordable to provide a balanced lawn tool with an impeller open to ambient air at all times, to add a small secondary wheel at the string trimmer head apex to impel heat and debris away from sensitive plastic materials without adding weight or extra tool load to a fixed point translation or rotary motor output which doesn't waste fuel during cutting operation, encourages the use of a cutting guard and improves the equilibrium of the tool in order to link contrasting lawn care routes comfortably and safely together with a lawn edging route.

U.S. Pat. No. 6,701,623 B2 discloses a primary handle having a transverse secondary handle. The disadvantage of this invention is that safety could be jeopardized when attempting to rotate the secondary handle into a mock vertical edging position because the throttle control handle slips away from an index finger as soon as the tool assembly is rotated into a new operating position. Furthermore, the secondary handle is described as rotating away from an operator into a stowed position which orientates the operator's stride closer to dangerous cutting tool regions. Best use tool standards should never encourage operation of a tool from a stowed position because labor standards are usually unassociated with inoperable stow positions of tools. Furthermore, lawn tools should never be stowed in a cardboard box after being operated at high temperatures with electric current or gasoline power sources because cardboard is made of combustible material. This invention becomes cumbersome to operate when the secondary handle must be set on the ground to loosen or tighten a clamp each time lawn care functions are changes. The primary handle decline grip of this invention does not counterbalance with the secondary grip which remains parallel to the lawn surface when held making this invention a disadvantage to hold and operate at all times. The clamp must not remain loose in this invention or the secondary handle will slide out of socket from vibration which is also potentially dangerous. Both handle grips are transverse over the boom which doesn't hold a center of gravity in three dimensional space when rotated. The secondary handle and grip can collapse when operated and consequently injure the operator. This invention does not stress the importance of keeping the clamp locked during operation which could pose a problem when switching back and forth during 256 possible trimming, edging, normal-duty, and heavy-duty blowing combinations. The harness will roll up and down between horizontal to vertical operation which disorientates the operation. Finally, the transverse secondary handle grip could easily become tangled up with a harness when properly rotated. Thus, the accessory harness of this invention is less likely to be used by an operator.

U.S. Pat. No. 5,768,749 requires a large volute to house an impeller which obstructs the view and length of combined string line material and adds weight to the tool assembly. The blower has more sensitive flat surface material to prevent from warping during combined trimming and blower operation. The invention requires two or more nozzles to be interchanged to adjust the air discharge pattern of the blower. The invention is unable to pivot a vertical impeller up and down to evenly distribute a uniform diagonal vortex. The diagonal vortex is required to steer debris laterally away from corners and longitudinally over tall curbs at a lower vortex end as debris is prevented from deflecting upward at a higher vortex end. This invention is at a disadvantage because the trimming and edging routes require one or more additional tool attachments to be carried, assembled and used in order to correspond with a blower route. The lawn tool doesn't offer a line of symmetry on the front handle to provide comfortable lawn care along corresponding lawn edging and heavy-duty blower routes which is a big disadvantage of this invention. Hence, it would be good to offer a lawn tool that can disperse mower clippings and lawn trimmings safely over tall curbs and away from corners with a heavy-duty more downward blast of concentrated airflow with the same nozzle or an upright motor to hold the lawn tool in a heavy-duty position.

A number of field tests have been performed on patent application Ser. No. 11/585,707, filed on Dec. 9, 2006, because of 3 tools being combined into 1 to do work in about half the time which can build up heat. In one such test, a 2×4×8 inch piece of wood was subjected to Ser. No. 11/585,707 with operable 17 inch diameter string line filament and a 6 inch operable impeller inside a covered blower and further tested with operable 17 inch diameter string line filament and an operable impeller with an uncovered blower to simulate the power and heat effects of lawn edging after 20 minutes of lawn edging. The test comparison showed that the Ser. No. 11/585,707 torque dropped nearly in half when the blower was covered. The Ser. No. 11/585,707 test further showed that heat significantly built up in the combined tool assembly when the blower was covered. Another finding showed that the uncovered blower test caused the operable blower performance to drop nearly 25%, but the tool bearing heat continued rising beyond the string line filament seizing point with a covered blower. The Ser. No. 11/585,707 lab tests addressed a need to cut off the rotating string when the blower is made operable to save on fuel consumption and to further protect lawn furniture during blower operation. However, cutting string line off is after the trimming and edging operation has been completed doesn't address heat generation with the covered blower and the steps can become cumbersome. The Ser. No. 11/585,707 tests further showed that ambient air travels through the uncovered blower when heat is released from to stabilize the tool temperature. The Ser. No. 11/585,707 tests concluded that the impeller or primary wheel should stop operation when the string line filament is made operable with a secondary wheel outside of the blower.

Mr. Hashimoto at Nippon Kries, Mr. Miyamoto at Chiba-factory and Mr. Nemoto and Yasuda at Marutecs tested the load of a Maruyama CER300 engine on Ser. No. 11/585,707 from a technical standpoint. It was discovered from the CER300 engine lab tests that the load was too high on the engine during certain times of operation. The engine lab test further showed a need to prevent the engine clutch from continuously slipped from more than 500 rpm of motor speed reduction after a load was put on the operable string trimmer by an inoperable blower and operable impeller/drive shaft. Shortening the string line for Ser. No. 11/585,707 addressed part of the problems associated with heat build up when the motor clutch slipped, but removing about 11 inches of string line would be required to improve blower performance by 30% and the operable blower will continue to disturb the string line fluid motion which reduces lawn care quality. The operable impeller and operable string trimmer head will add more fuel and string line filament costs to lawn care operation and will be more time consuming.

The above lawn tool combination shortcomings are limited in addressing current problems associated with making lawn care routes more efficient. Lawn care specialists generally begin lawn trimming operation from a base before blowers are operated to provide a nice lawn appearance. Lateral lawn growth is edged on lawn perimeters along edging routes capable of being linking to interior lawn trimming routes nearest to interior trimming route transport legs. Blower routes are typically operated outside of lawn interiors commonly linked to lawn edging routes to impel debris preferably away from the lawn tool operation into a lawn interior. Trimming routes are dissimilar to blower routes because interior lawn trimming operation generally hides debris whereas lawn edging operation generally exposes significant debris where the blower operation is required to impel and hide debris from an opposite side of a lawn perimeter into lawn interiors. A difficulty associated with completing lawn care operation is the linking of lawn tools to dissimilar lawn care routes which may involve repeated short and long transport routes between lawn care operation. Mowers can be used effectively to remove debris along dissimilar blower routes after mowing is completed, but mowers are limited to horizontal lawn care and they have a difficult time getting into tight corners. Hence, the present invention can be operated from a mower fixed point without having to hold onto power tools, connect tools or loosen and tighten tools by hand.

An outcome when combining lawn tool operation on trimming, edging and blower routes results from the industry's misunderstanding the problem it is addressing. The industry perceives that the problem is rotating the trimmer string plane in two-dimensional xz space, that is, moving a horizontal plane into a vertical plane of a straight shaft trimmer with a 90° clockwise boom rotation for a right-handed operator or counterclockwise for a left-handed operator. In reality, the rotation must be considered in three-dimensional xyz space because the entire lawn care apparatus is being rotated, not simply the working head and so the orientation of the drive shaft housing and handles changes when the cutting head and rotating string are rotated. In some cases, lawn tools can be folded at a tool origin and at a handle origin to align lawn edging routes with an operator, but this extra bending of tools and several presses, twists and turns by an operator obstructs the view and route of edging operation and can eventually damage the lawn tool. Aligning the lawn tool at the tool origin instead of rotating the full devise further positions the operator behind the edging transport route where common walls, elevated curbs, cliffs, parked vehicles, landscape beds and debris can interfere and become dangerous with the operation.

Geometrically speaking, all lawn tools can be held on a boom line of symmetry with the boom forming 12 orthogonal isometries, that is, 8 lateral folds and 4 longitudinal folds with 1 lateral isometry being the closest fold for combining a view of the tool operation and lawn care route together with safety in mind as mentioned in detail below. Longitudinal 90 degree folds for trimming, edging and blowing are generally forbidden for lawn care, but longitudinal folds can be used to orientate tree trimming booms, paint sprayers and the like in vertical equilibrium as a nozzle disperses debris away from possibly exposed safety goggles under equilibrium. Hence, an operator can align a harness central to a vertical line of symmetry to hold a power tool in equilibrium at a fixed point in order to minimize lateral folds between trimming, edging and blowing operation. When limiting lateral folds to lawn care, there are 2 degrees of vertical isometry for every 1 degree of lateral isometry with respect to lawn tools providing a line of symmetry for a boom with 3 degrees of congruent rotation at the fixed point of equilibrium. One fold of symmetrical operation for edging, trimming and blowing will prevent operators from walking sideward or backward to view work, lower the operating fatigue factor by creating less work and reduce danger of being hit by passing motor vehicles that are difficult to see or hear when the motor is blocking the view of an operator.

An example of two lateral folds is to grasp a spatula mounted to a strict 45 degree longitudinal angled boom handle and longitudinally translate the spatula base between a golden blown pancake on a griddle with a transposed grip to flip the pancake over laterally 180° degrees east to west for a golden blown finish on both sides, then the spatula handle can be tilted 90° degrees south to north into a vertical position to slice through the pancake by translation on the front edge of the spatula. Using either hand on the same spatula can produce 1 fold with an underhand grip by tilting the spatula 90° degrees east to west into a vertical position, then by raising the spatula at the same angle of the prior spatula boom handle angle thereby allowing the pancake to be cut in half by translation of the spatula's side edge. Work becomes significantly less for an operator when the pancake analogy is applied to larger and heavier booms. In fact, there is a concern that many common lawn tools operate in a second group rotation which exposes string line to an operator and draws an operating framework further away from the operator transport route. Another concern is to shorten the fold which keeps the throttle control as close to an index finger as possible without considering additional safety factors. The present invention will provide an optimal fold option to operate 3 combined tools in equilibrium on 3 effective corresponding routes, and the current invention can be held in balance as a combined 2 in 1 lawn tool if so desired.

Having the average holding height proportional to about the 31 inch average stride of an operator and the lawn cutting plane radius generally set at about 9 inches shows by default that the tangential tool assembly can be orthogonally rotated into 8 tetrahedron rigid bodies with respect to the motor assembly translating into 8 opposite tetrahedron rigid bodies. Therefore, a handlebar affixed to a lawn tool boom may be rotated or translated congruently within 1 orthogonal isometry with respect to a tool assembly and a motor assembly being congruently locked into the same orthogonal isometry. The lawn care apparatus can be bound more specifically to two right isosceles tetrahedrons sharing their smallest legs along the vertical line of symmetry when an operator facilitates a cross-over shoulder harness in relation to a pair of orthogonal handlebar grips aligning to the fixed point between the motor and tool line of symmetry along the longest legs of the right isosceles tetrahedrons. It can be shown that the handlebar orbits without being transverse or collapsing to control lateral and longitudinal oscillation. The fixed point holds the tool assembly in equilibrium with the heavier motor assembly mass being bound to the smaller tetrahedron and the lighter tool assembly mass being bound to the larger tetrahedron. A blower being the first tangential tool on the line of symmetry may be rotated between a vertical and horizontal plane and locked between 1 of 8 right isosceles tetrahedron operating frameworks. Furthermore, the present invention cutting guard, string trimmer head, blower and other attachments may be connected tangential to the line of symmetry and locked into 1 of 8 right isosceles tetrahedron operating frameworks by distributing the weight congruently within symmetrical rigid bodies that orbit at a fixed point. The present invention further allows tool connections from the gearbox or at ground level without a mechanical tool to vertically or horizontally tend vegetation with a line of symmetry from the motor to the tool assembly.

Combining lawn trimming and edging routes reduces transport time which may be why 2 in 1 trimmers continue growing in popularity. Another reason why string trimmers are typically used as edgers is to groom large grounds areas quickly and consistently due to weather, timing and labor constraints. However, combining edging along hard surfaces and trimming deep within interior lawns for long periods of operation can cause more heat to build up at the tool and motor end which can lead to sensitive string line or motors seizing. Furthermore, restricting combined lawn tools to dissimilar routes has more potential to fatigue an operator. Tests on average size ⅓ acre lawns show that a properly designed trimmer, edger and blower can be operated on a lawn care route about twice as fast as more expensive 2 in 1 lawn tools because the blower route will follow a lawn edging return route back to the base. The 2 in 1 trimming and edging operation can facilitate heat reduction by adding a secondary wheel to the cutting tool and by providing a blower with an open airflow section to release heat and air pressure at all times, that doesn't add more load to to the motor operating speed and will exchange heat faster from tools by providing more ambient air through the blower to release significant heat volume out of the tool assembly.

Many times a lawn power tool motor is flipped on its side often moving the piston lower than the crankcase, allowing excess oil to enter the combustion chamber, thereby increasing pollution and denying sufficient lubrication to the piston rod and crankshaft, and this complicated co-rotation frequently places the muffler adjacent to the operator's head. Some manufactures can charge and receive high payment for installing oil pumps to rotate lawn tool motors 360 degrees which doesn't address possible hearing loss, environmental spills, lung or nerve ailments, skin burns, shredding of long hair from motor flywheels, damaged clothing and other potential safety hazards from 360° degree orbital lawn motors. Either an electric motor, gasoline engine or new power source can be held into an upright position at all times with the present invention because the power source is rigidly connected to a handlebar that reverses the motor orientation into an upright position. An upright power source is an important safety concern as more powerful batteries become available that can provide dry as well as wet power cells for mowing, edging, trimming and blowing work which can leak when rotated. In the case of a gasoline engine string trimmer, rotating inexpensive engines can result in crankcase oil finding its way into the combustion chamber, causing the engine to bog down or stall during edging which can shorten the life of the sparkplug and the engine. Gasoline fumes should also be behind an operator during lawn care operations which the present invention provides for. Providing the same upright power source position with similar rotary load capability during trimming, edging, normal-duty blowing and heavy-duty blower work would be a welcome advancement to the US lawn care industry. Many lawn tools provide motors at the tool end, but this feature can force lawn care combinations out of equilibrium where the combined tool downward force is far away from a torso forcing an operator out of balance and draws cutting tools closer to operators. More weight distribution at a tool end increases the possibility of tool damage when an operator slips a grip on one handle which in turn forces the heavier tool end to drop onto the ground. A center of gravity is lost when lawn tools are extended down difficult pond slopes that mowers can not reach or when the tool frequently swings back and forth to cut through thick brush. This may even cause an operator to slip into a pond with an electric motor or the like.

A police force is trained to protect society with a steady hand on a boom trigger at all times which begs to question why lawn care operators are forced to let go of 2 in 1 lawn tool boom triggers or the like when performing lawn edging. A common way to hold onto a 2 in 1 trimming and edging power control trigger is by rotating a handle 90 degrees from a comfortable trimming position into a mock edging position which pulls an index finger 90 degrees inversely away from the power control trigger and leaves the cutting angle offset. The quickest way for straight shaft trimming operators to correct the mock edging angle is to remove the cutting guard which permits string line filament to be raised to waist level for a vertical lawn edging position. Lifting the handle to provide a vertical cut without a cutting guard puts magnitude stress on an operator's torso, the longer string line load wastes fuel and is hard on expensive moving parts that can draw more debris back towards the operator. Bent shaft 2 in 1 trimmers are commonly operated for edging about twice as far as straight shaft 2 in 1 trimmers for edging because even numbered group rotations provide longitudinal symmetry to the side of an operator which is a disadvantage compared to straight shaft edgers that align closer to the transport route, but the straight shaft cutting angle is inferior which forces more professional lawn care providers to buy and operate vertical steel edgers. Reversing the present invention boom motor assembly with the boom tool assembly permits accurate cutting with a cutting guard without having to buy a steel edger for a straight cut.

Before trimming and edging lawns there are objects like glass, rocks and trash that should be removed before they become dangerous projectiles. Hence, the operating route should be progressing in front of the operator. On the other hand, orientating string trimmer heads between horizontal and vertical planes is not as simple as a 90 degree turn of a handle and may complicate the 2 in 1 trimming and edging process. Combined edging and trimming tools should be equipped with a cutting guard that blends vertical wall protection for trimming with lateral wall protection for edging to further restrict harmful flying objects from dispersing towards an operator. Cutting guards not only should protect an operator from flying objects during vertical edging and horizontal trimming operation, but can also reduce wear and tear to clothing and lower chemical cleaning costs. Electrical wires, limbs, bystanders and property overhangs should be viewed by the operator at all times to avoid accidents. The present invention cutting guard not only aligns symmetrically in front of the operator between the lawn cutting surface to protect the operator, but the wing ends can be extended as 90° degree vertical guides to show when to stop edging under overhangs with a lawn tool that can clip wires or vegetation rather easily. Proper attire like ear plugs, glasses, hard boots and full clothing to conceal long hair and the like should be properly fitted and comfortable to wear to further prevent lawn care accidents. Keeping the cutting tool substantially in front yet offset from the operator helps to avoid being hit by oncoming traffic, prevents the operator from tripping over stoops, discourages lawn care providers from walking backwards, prevents operators from slipping off curbs or walls and averts landscapers from running into stationary or moving objects in line with the work area which the present invention provides for.

A perception that rearward debris motion should be avoided during lawn edging can be misleading when lawn tools can be offset at a diagonal angle with forward momentum of an operator which can immediately provide windshield protection to an operator where debris is released low and away from an operator whereas lawn edging clippings dispersed forward are scooped up higher with centrifugal force and impelled towards an operator after being able to gain momentum without immediate windshield protection during common headwind edging operation. Tests show that dispersing debris forward during the edging process is an interesting problem because it actually encourages debris shields to be removed from many inferior lawn tools without addressing centrifugal string line motion that tends to scoop up debris and hurl it back towards an operator. Hence, there are key safety benefits to consider that would allow debris to fly low to the ground with less thrust to the left side of an operator when facilitating an immediate shield guard whereas debris can be thrusts upward in front of an operator which is likely to allow flying debris to gain momentum without a windshield guard. When the edging operation is to the right of an operator the present invention has a blower nozzle that acts as a windshield to stop debris from gaining momentum in a headwind. The present invention assists operators with safety both with forward and rearward rotary tool motion by maintaining the lawn edging operation offset from the operator transport route which is further assisted by a handlebar that pivots the trimming operation offset from the operator to enhance lawn care safety no matter what symmetrical position the present invention is operated from.

Lawn edging of St. Augustine grass between 2006/2007 supported a need to cool off the present invention during prolonged trimming and edging routes and that heat must be able to escape upward as ambient air follows through the blower without interference to string line motion. Therefore, the present invention now employs a permanently open blower section that faces an operator and a permanently closes blower section facing a string trimmer head. The string trimmer head consists of a secondary wheel to impel debris and heat away from the tool assembly. The secondary wheel works like a radiator on an automobile and even blasts debris away during trimming and edging operation without vacuum. In addition, the primary wheel of the present invention is connected to the boom allowing the motor to be released from the primary wheel when the blower air inlet and air outlet are open and the blower is made inoperable. The present invention trimming and edging operation also saves about 25% on fuel costs by reducing the motor load when the cutting tool is operated. The present invention also eliminates overall weight of the motor by translating the motor clutch to the tool assembly after reducing the weight of the impeller cover and by shrinking the height of the blower housing section to limit airflow and heat problems associated with combining lawn tools. Therefore, the present invention eliminates the need of a blower air inlet and air outlet cover to drastically reduce heat in the tool assembly during trimming and edging operation. The motor rotary power is axial translated by a shifter about midway between the motor and tool assembly without the drive shaft being connected to an impeller to further eliminate the need of bending over to handle heavy levers near the cutting tool. The present invention 4 in 1 lawn tool operation provides substantially equal motor speed whether completing trimming, edging, regular-duty or heavy-duty blowing which should be given serious consideration for this invention. The motor load of the present invention can be kept steady with a slightly more downward force put on either handlebar grip between the harness to align the string line filament leading tip at a ground surface instead of deep into the ground by a wheel and rigid blade which can cause damage to mechanical devices and vegetation.

The present invention provides a tangential blower, cutting guard and string trimmer that operates and translates along a convenient lawn care route by an ergonomic handlebar control system. The tool assembly folds into one isometry, that is, a narrow and wide framework for edging, trimming, normal blowing and heavy-duty blowing lawn care operations. The narrow blower framework generates more concentrated airflow, having the ability to pull debris out of corners or easily over steep 8 to 10 inch curbs whereas the wide blower framework is used for general purpose fast debris clean up. The handlebar consists of a gearbox to generally regulate orientation of the boom being held at the fixed point between the tool assembly narrow and wide operating frameworks in response to a power assembly maintaining an upright position behind an operator. The gearbox providing one or more side hubs to couple a side control handle held with an incline grip to a power control handle held with a decline grip at a gear center of rotational symmetry. Hence, the incline grip of the side control handle will transpose onto a lateral line of symmetry when held in a narrow operating framework and the decline grip of the power control handle will transpose onto a longitudinal line of symmetry when held in a wide operating framework without being transverse over the boom or collapsing. Affixing the handlebar to a longitudinal and lateral line of symmetry between wide and narrow operating frameworks and setting the harness to a vertical line of symmetry allows operators to significantly balance the lawn care apparatus in 3 dimensional space in order to minimize safety concerns which should be given serious consideration with this invention.

### BRIEF SUMMARY OF THE INVENTION

The primary object of the invention is to provide a lawn care apparatus with a center of gravity when performing lawn care operation. center of gravity when performing lawn care operation.

Another object of the invention is to provide the lawn care apparatus with a motor assembly behind an operator breathing passages that remains upright when held.

Another object of the invention is to provide the motor with equal operating speed at wide open throttle when performing combined lawn care apparatus field tests.

A further object of the invention is to provide continuous power from the motor assembly when performing lawn care operation.

Yet another object of the invention is to provide the lawn care apparatus with a tangential tool assembly to combine lawn care operations.

Still yet another object of the lawn care apparatus is to provide the lawn care apparatus with auxiliary tool assemblies at or near a tool assembly origin without the use of a tool.

Another object of the invention is to provide axial and rotary drive motion from the motor assembly to beyond the tangential tool assembly.

Another object of the invention is to provide the tangential tool assembly with a cutting and blowing operating framework.

A further object of the invention is to provide the cutting operating framework with cutting guard protection aligned substantially parallel to the lawn surface.

Yet another object of the lawn care apparatus is to provide the lawn care apparatus with a blower auxiliary tool assembly without the weight of a cutting guard.

Still yet another object of the lawn care apparatus is to provide the lawn care apparatus with a center of gravity between the tool assembly and the motor assembly.

Another object of the invention is to provide the lawn care apparatus with a wide and narrow operating framework with respect to 8 orthogonal isometries.

Another object of the invention is to provide the narrow and wide operating frameworks with a forward translation from a lawn care base locked into 1 orthogonal isometry.

A further object of the invention is to provide the narrow and wide operating frameworks within hands reach without having to loosen or tighten clamps by hand.

Yet another object of the invention is to provide the narrow operating framework with a heavy-duty blower path corresponding alongside a lawn perimeter edging route.

Another object of the invention is to provide the narrow operating framework upward load with balanced downward force at the fixed point.

Still yet another object of the invention is to provide the wide operating framework with a lawn interior trimming path corresponding with legs of the lawn perimeter edging route.

Another object of the invention is to provide the interior lawn trimming and perimeter lawn edging routes with 25% fuel savings by facilitating axial drive motion to rotate 1 tool.

Another object of the invention is to provide the blower route on a return route to the lawn care base alongside the lawn edging route and dissimilar to the interior trimming route.

A further object of the invention is to provide the blower route with a permanent oblong nozzle having a sufficient width and length to discharge air in 1 or more vortex planes.

Yet another object of the invention is to provide the narrow and wide operating frameworks with 4̂4=256 different lawn care combinations.

Still yet another object of the invention is to provide the lawn care apparatus with gas and heat release at all times to prevent harm of sensitive materials.

Another object of the invention is to provide the lawn care apparatus with a cutting guard when a cutting tool is operated aligned symmetrically to the lawn surface to prevent harm to the operator from flying objects.

Another object of the invention is to provide the lawn care apparatus with a shortened lawn care route that consumes less energy.

A further object of the invention is to provide the lawn care apparatus with a series of stabilizers designed for less vibration and noise.

Still yet another object of the invention is to provide the lawn care apparatus with an exclusive narrow operating framework for an auxiliary edger for more rigid lawn care.

Yet another object of the invention is to provide the lawn care apparatus with a skid that helps the tool assembly glide over lawn surfaces.

Another object of the invention is to provide the lawn care apparatus with a fixed point that can affix to a mower fixed point to balance combined loads and forces.

Still yet another object of the invention is to provide the lawn care apparatus with gas and heat release at all times to prevent harm of sensitive materials.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for A COMBINATION BLOWER, EDGER AND TRIMMER AND METHOD FOR TENDING VEGETATION comprising: a motor assembly including the motor, a motor housing, a power control handle, one or more power switches and a throttle control trigger, the motor assembly generally held by a boom from a fixed point proximal end to the motor distal end, a tool assembly including a cutting tool facilitated by a cutting guard typically mounted tangential to a blower, the blower mounted to the boom at a tool distal end, the cutting tool generally made up of a string trimmer head having a secondary wheel without a hub facing the blower, the secondary wheel having 5 air vanes for odd numbered air frequencies, the tool assembly generally held in front of an operator by the boom from the fixed point to the blower, the blower including an oblong nozzle open to ambient air at all times and a primary wheel with a base plate open to ambient air on a flue side and shielded on the opposite side to cutting tool clippings, the blower having an arrow orientating the oblong nozzle and tool attachments between 1 orthogonal isometry, a drive shaft contained within the motor assembly at the motor boom end translated beyond the boom between the primary and secondary wheel plates, the drive shaft held in equilibrium at a fixed point, the drive shaft having means to translate axially between the impeller plate and cutting plate by a shifter mounted near the fixed point when the motor is operated at idle speed, the drive shaft having means to rotate axially the cutting tool or the impeller with respect to the motor operating speed being substantially equal at wide open throttle, the primary wheel having 9 air vanes for odd numbered air frequencies, the oblong nozzle operated between about a 2.5 inch blowing width and about a 1 inch width, the blower having 8 or more outer wall fasteners lining up to a plurality of blower attachment fasteners, the blower generally operated alongside lawn perimeter edging return routes, the cutting tool generally made up of string trimmer head having a detachable spool string line filaments 8.5 inches in radius, a handlebar mounted axial to the fixed point, the handlebar balanced at the fixed point, the handlebar orbits without collapsing, the handlebar having a gearbox mounted longitudinally to the boom, the gearbox having a left and right lateral hub, the left hub having a clamp preventing the handlebar diagonal grips from being pulled towards the operator, the handlebar having the power control handle mounted longitudinal to the boom 5 inches behind the fixed point, the handlebar having a side control handle mounted within a gearbox hub 5 inches in front of the fixed point, the side control handle operated without hand operating a clamp, the side control handle coupled to a beveled gear, the side control handle having means to reverse the axial rotation of the power control handle at the fixed point, the side control handle having means to reverse the throttle control trigger at the fixed point, the side control handle having means to maintain an index finger on the throttle control trigger and the like at all times, the side control handle having an incline grip for lawn trimming or normal blowing of vegetation, the incline grip having means to transpose onto itself, the incline and decline grips line up diagonal between the fixed point, the side control handle rotation vector congruent in relation to the tool assembly coordinate system, the incline grip on the boom line of symmetry in the narrow operating framework, the decline grip on the boom line of symmetry in the wide operating framework, the side control grip having an incline grip of 30 vertical degrees slanted away from the shaft and 15 degrees lateral towards the power control handle, the power control handle having one or more power cut off switches, the gearbox having longitudinal front and rear bores to align the booms, the gearbox hub having means to lock the side control handle and power control handle from rotation, the gearbox having one or more lateral beveled gears, the lateral beveled gears having about 32 teeth, the lateral beveled gears having one or more indents to mount the side control handle, the gearbox having a longitudinal beveled gear, the side control handle having means to crank one or more beveled gear mounted within the gearbox in a 1:1 ratio or the like, the longitudinal beveled gear having about 32 gear teeth or the like, the longitudinal beveled gear operatively connected within the gearbox to the lateral gear with 1 or more fasteners, the fasteners lock in a plurality of positions to adjust the height of the side control handle, the longitudinal beveled gear having means to crank the rotary motor housing in a reverse 1:1 ratio or the like with the side control handle, the longitudinal beveled gear having 2 opposite addendum spaces filled in to form a pair of cam locks, the cam locks having means to lock the handlebar in the wide and narrow operating framework operating without loosening a fastener, the cutting guard having about a 70 degree radian surface to protect an operator in the narrow operating framework with respect to the lawn edge aligning with either side of the cutting guard, the cutting guard having about a 70 degree wall with 10 degree flare outs of protect an operator in the wide operating framework with respect to the lawn surface aligning with the cutting guard wall, the flare outs used as edging guides, the cutting guard having a skid, a lawn care edging route starting near a base or delivery point with respect to the string trimmer head aligned,in a narrow operating framework within a right isosceles tetrahedron isometry framework, a lawn care trimming route coinciding with the lawn care edging route with respect to the string trimmer head aligned within the wide operating framework within the right isosceles tetrahedron isometry framework, a lawn care blower route coinciding with the lawn care edging return route with respect to the oblong nozzle aligned within the wide or narrow operating framework to the lawn surface within the right isosceles tetrahedron isometry framework, and the lawn care apparatus bound within a path of least resistance.

In accordance with a preferred embodiment of the invention, there is disclosed a process for A COMBINATION BLOWER, EDGER AND TRIMMER AND METHOD FOR TENDING VEGETATION comprising the steps of: a motor assembly including the motor, a motor housing, a power control handle, one or more power switches and a throttle control trigger, the motor assembly generally held by a boom from a fixed point proximal end to the motor distal end, a tool assembly including a cutting tool facilitated by a cutting guard typically mounted tangential to a blower, the blower mounted to the boom at a tool distal end, the cutting tool generally made up of a string trimmer head having a secondary wheel without a hub facing the blower, the secondary wheel having 5 air vanes for odd numbered air frequencies, the tool assembly generally held in front of an operator by the boom from the fixed point to the blower, the blower including an oblong nozzle open to ambient air at all times and a primary wheel with a base plate open to ambient air on a flue side and shielded on the opposite side to cutting tool clippings, the blower having an arrow orientating the oblong nozzle and tool attachments between 1 orthogonal isometry, a drive shaft contained within the motor assembly at the motor boom end translated beyond the boom between the primary and secondary wheel plates, the drive shaft held in equilibrium at a fixed point, the drive shaft having means to translate axially between the impeller plate and cutting plate by a shifter mounted near the fixed point when the motor is operated at idle speed, the drive shaft having means to rotate axially the cutting tool or the impeller with respect to the motor operating speed being substantially equal at wide open throttle, the primary wheel having 9 air vanes for odd numbered air frequencies, the oblong nozzle operated between about a 2.5 inch blowing width and about a 1 inch width, the blower having 8 or more outer wall fasteners lining up to a plurality of blower attachment fasteners, the blower generally operated alongside lawn perimeter edging return routes, the cutting tool generally made up of string trimmer head having a detachable spool string line filaments 8.5 inches in radius, a handlebar mounted axial to the fixed point, the handlebar balanced at the fixed point, the handlebar orbits without collapsing, the handlebar having a gearbox mounted longitudinally to the boom, the gearbox having a left and right lateral hub, the left hub having a clamp preventing the handlebar diagonal grips from being pulled towards the operator, the handlebar having the power control handle mounted longitudinal to the boom 5 inches behind the fixed point, the handlebar having a side control handle mounted within a gearbox hub 5 inches in front of the fixed point, the side control handle operated without hand operating a clamp, the side control handle coupled to a beveled gear, the side control handle having means to reverse the axial rotation of the power control handle at the fixed point, the side control handle having means to reverse the throttle control trigger at the fixed point, the side control handle having means to maintain an index finger on the throttle control trigger and the like at all times, the side control handle having an incline grip for lawn trimming or normal blowing of vegetation, the incline grip having means to transpose onto itself, the incline and decline grips line up diagonal between the fixed point, the side control handle rotation vector congruent in relation to the tool assembly coordinate system, the incline grip on the boom line of symmetry in the narrow operating framework, the decline grip on the boom line of symmetry in the wide operating framework, the side control grip having an incline grip of 30 vertical degrees slanted away from the shaft and 15 degrees lateral towards the power control handle, the power control handle having one or more power cut off switches, the gearbox having longitudinal front and rear bores to align the booms, the gearbox hub having means to lock the side control handle and power control handle from rotation, the gearbox having one or more lateral beveled gears, the lateral beveled gears having about 32 teeth, the lateral beveled gears having one or more indents to mount the side control handle, the gearbox having a longitudinal beveled gear, the side control handle having means to crank one or more beveled gear mounted within the gearbox in a 1:1 ratio or the like, the longitudinal beveled gear having about 32 gear teeth or the like, the longitudinal beveled gear operatively connected within the gearbox to the lateral gear with 1 or more fasteners, the fasteners lock in a plurality of positions to adjust the height of the side control handle, the longitudinal beveled gear having means to crank the rotary motor housing in a reverse 1:1 ratio or the like with the side control handle, the longitudinal beveled gear having 2 opposite addendum spaces filled in to form a pair of cam locks, the cam locks having means to lock the handlebar in the wide and narrow operating framework operating without loosening a fastener, the cutting guard having about a 70 degree radian surface to protect an operator in the narrow operating framework with respect to the lawn edge aligning with either side of the cutting guard, the cutting guard having about a 70 degree wall with 10 degree flare outs of protect an operator in the wide operating framework with respect to the lawn surface aligning with the cutting guard wall, the flare outs used as edging guides, the cutting guard having a skid, a lawn care edging route starting near a base or delivery point with respect to the string trimmer head aligned in a narrow operating framework within a right isosceles tetrahedron isometry framework, a lawn care trimming route coinciding with the lawn care edging route with respect to the string trimmer head aligned within the wide operating framework within the right isosceles tetrahedron isometry framework, a lawn care blower route coinciding with the lawn care edging return route with respect to the oblong nozzle aligned within the wide or narrow operating framework to the lawn surface within the right isosceles tetrahedron isometry framework, and the lawn care apparatus bound within a path of least resistance.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1a is an isometric view of a combination blower, trimmer and edger for tending vegetation illustrating the ( lawn care apparatus) with a line of symmetry on the power control handle in a wide operating framework for trimming inside interior lawns with a cutting guard.

FIG. 1b is an isometric view of the lawn care apparatus of FIG. 1a illustrating the lawn care apparatus with a line of symmetry on the side control handle which is accomplished by rotating the handlebar 135 degrees from the wide operating framework into a narrow operating framework for edging on lawn perimeters with a symmetrical cutting guard.

FIG. 2a is an isometric view of a combination blower, trimmer and edger for tending vegetation illustrating the lawn care apparatus of FIG. 1a with a line of symmetry on the power control handle in a wide operating framework for normal-duty blowing of debris outside of lawn perimeters which is accomplished by simultaneously rotating the handlebar 90 degrees longitudinal and 45 degrees lateral from the narrow operating framework back into the wide operating framework.

FIG. 2b is an isometric view of the lawn care apparatus of FIG. 1a illustrating the lawn care apparatus with a line of symmetry on the side control handle in the narrow operating framework for heavy-duty blowing of debris outside of lawn sections which is accomplished by simultaneously rotating the handlebar 90 degrees longitudinal and 45 degrees lateral from the wide operating framework back into the narrow operating framework.

FIG. 3 is a fragmentary isometric of the lawn care apparatus of FIG. 1a illustrating the motor assembly rotary and axial translation of the drive shaft by the shifter located near the fixed point.

FIG. 4a is a top view of the lawn care apparatus of FIG. 1a and 2a illustrating the side control handle coupled to the left gearbox hub that may also be coupled to the right gearbox hub which is accomplished by pulling up on the ball lock tap.

FIG. 4b is a side view of the lawn care apparatus of FIG. 1a and 2a illustrating the side control handle transposed onto itself when the wide and narrow operating framework is facilitated.

FIG. 4c is a side view of the lawn care apparatus of FIG. 1b and 2b illustrating the side control handle transposed onto itself when the narrow operating framework is facilitated

FIG. 4d is an exploded isometric view of the lawn care apparatus of FIG. 1a. illustrating the gearbox hub with a clamp that locks the tool and motor assembly into one operating position for extended use.

FIG. 5 is a top view of the lawn care apparatus of FIG. 1a illustrating the side control handle mounted to the right gearbox hub for right orientated trimming, edging and blowing operation and equilibrium.

FIG. 6 is a fragmentary isometric view of the lawn care apparatus of FIG. 1a-2b illustrating the tool assembly bound within 1 orthogonal 90 degree vertical and 45 degree lateral fold which is accomplished by affixing the tool assembly to a right isosceles tetrahedron rigid body.

FIG. 7a is an exploded isometric view of the lawn care apparatus of FIG. 1a- 2b illustrating the string trimmer head, cutting guard and blower, that is, the preferred embodiment.

FIG. 7b is a fragmentary isometric view of FIG. 7a illustrating the string trimmer head apex facilitating a secondary wheel for impelling debris outward and ambient air upward when the string trimmer head is operated.

FIG. 7c is a fragmentary enlarged side view of 7a illustrating the primary wheel connected to the boom free of the drive shaft with an open and closed airflow section to discharge air at all times.

FIG. 7d is an enlarged fragmentary side view of FIG. 7a and FIG. 2a illustrating the triple fluted rotating string: for more steady cutting.

FIG. 8 is an exploded isometric view of the the lawn care apparatus illustrating an alternative embodiment of FIG. 7a facilitating a lawn edger operated exclusively in a narrow framework for heavy-duty lawn edging and blowing.

FIG. 9 is an exploded isometric view of the lawn care apparatus of FIG. 2a-2b illustrating an alternative embodiment of FIG. 7a facilitating an exclusive blower generally operated during dormant lawn care seasons.

FIG. 10 is a flow chart of the lawn care apparatus of FIG. 1a-2b illustrating a lawn care route which progresses from a base on an edging route corresponding with a trimming route dissimilar to a blower route looping back to an edging route for the blower to generally correspond with the edging route when.

FIG. 11 is a curve plot of the lawn care apparatus of FIG. 1a illustrating the advantages and disadvantages of operable 17 inch rotating string with an operable and inoperable blower.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

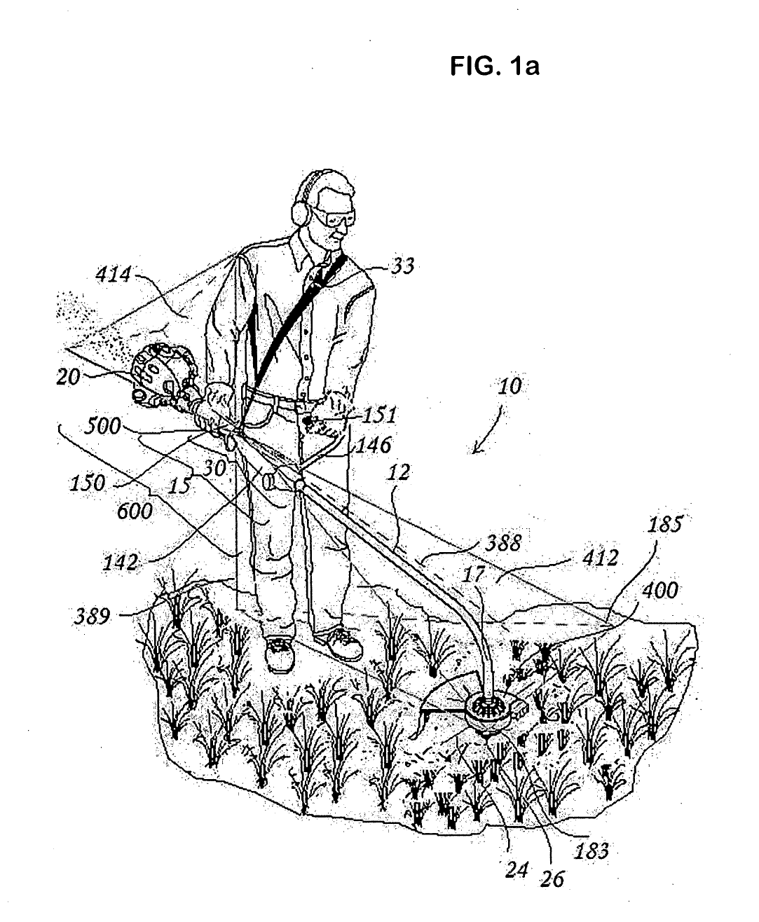

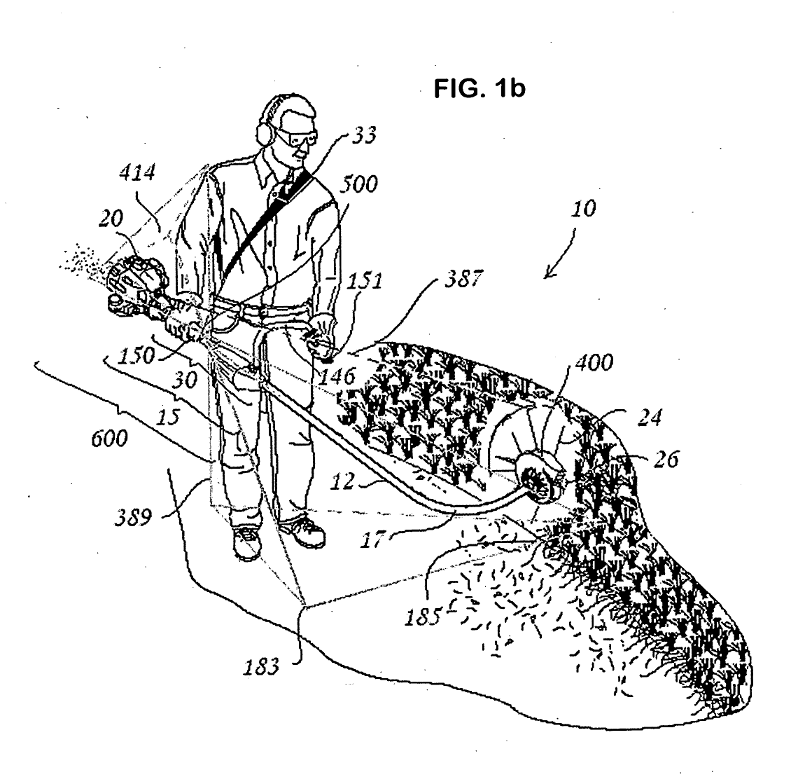

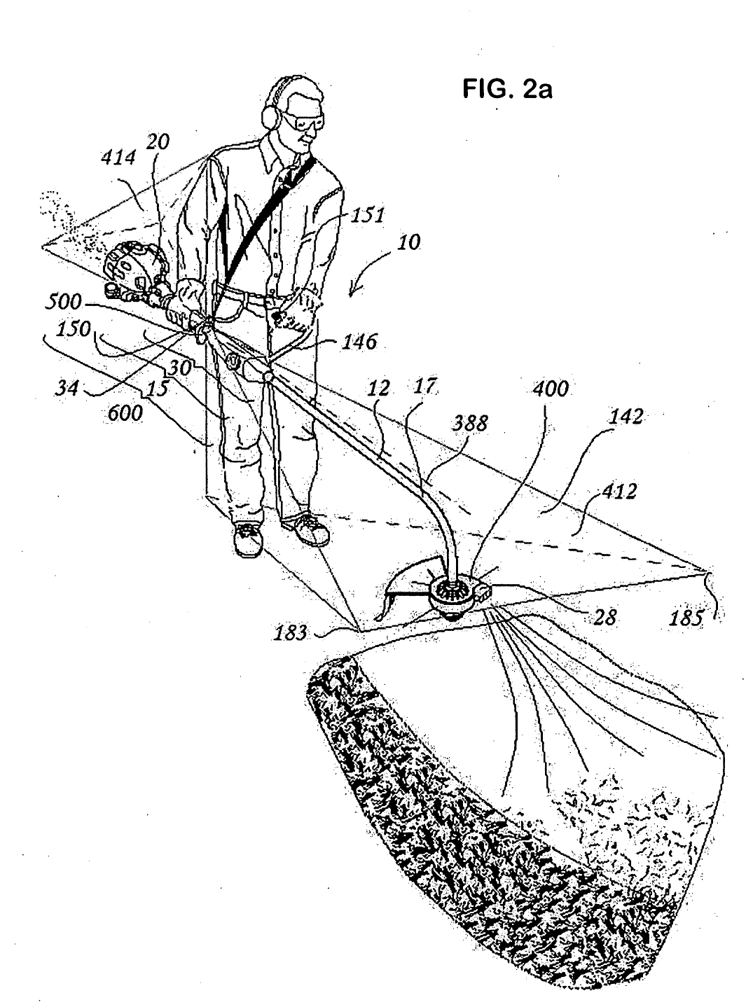

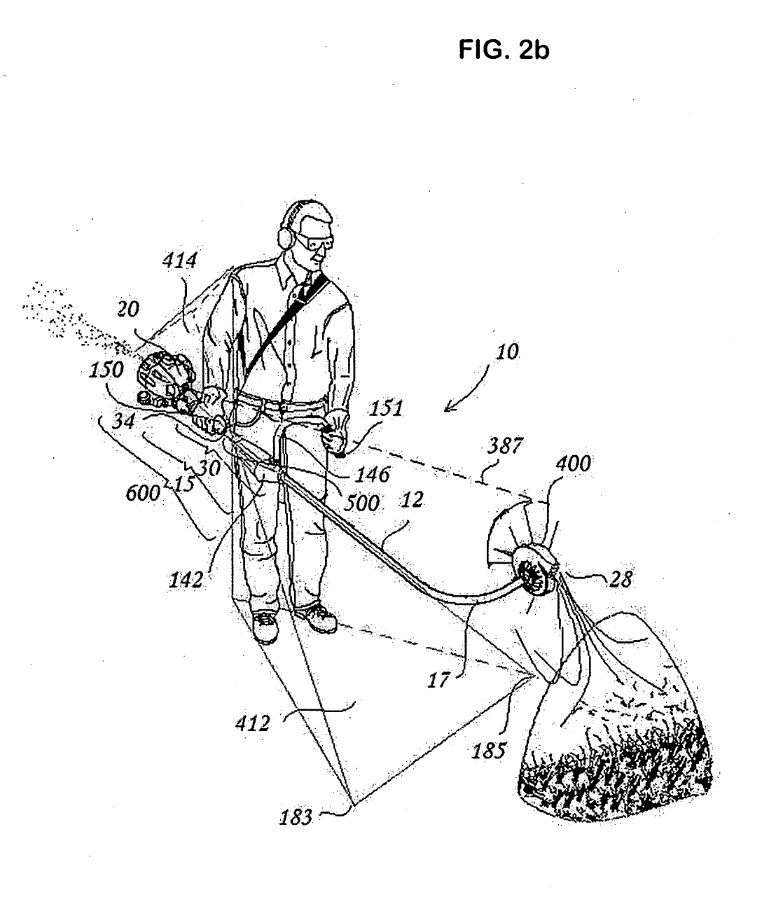

Referring to FIG. 1a-2b, a COMBINATION BLOWER EDGER TRIMMER METHOD FOR TENDING VEGETATION, that is, a lawn care apparatus, 10 according to the present invention including a handlebar 30 affixed proximal to a boom 12 consisting of a side control handle 146 lateral line of symmetry 387 and a power control handle 34 affixing to the boom 12 longitudinal line of symmetry 388 at a fixed point 500 of equilibrium. The boom 12 comprising a power segment 15 that translates a motor assembly 600 to the rear of an operator from the fixed point 500 to a motor 20 distal end in response to a tool segment 17 rotating a tool assembly 400 in front of the operator from the fixed point 500 to a blower 28 at a lateral tool 14 end. The booms 12 further provides a gearbox 142 to reverse the motor assembly 600 axial rotation congruently with the tool assembly 400 axial rotation. The side control handle 146 mounts to either side of the gearbox 142 and provides an incline grip 151 that transposes the boom 12 lateral 387 and longitudinal 388 lines of symmetry onto the tool assembly 400 wide 183 and narrow 185 operating frameworks. The power control handle 34 provides a decline grip 150 about central to the incline grip 151. The lawn care apparatus 10 can be affixed to a rotating right isosceles tetrahedron 390 rigid body and a congruent translating 395 right isosceles tetrahedron 395 where an accessory harness 33 provides a vertical line of symmetry 389 at the fixed point 500 to direct the lawn care apparatus 10 on a convenient lawn care route at all times of operation without being obstructed by the side control handle 146.

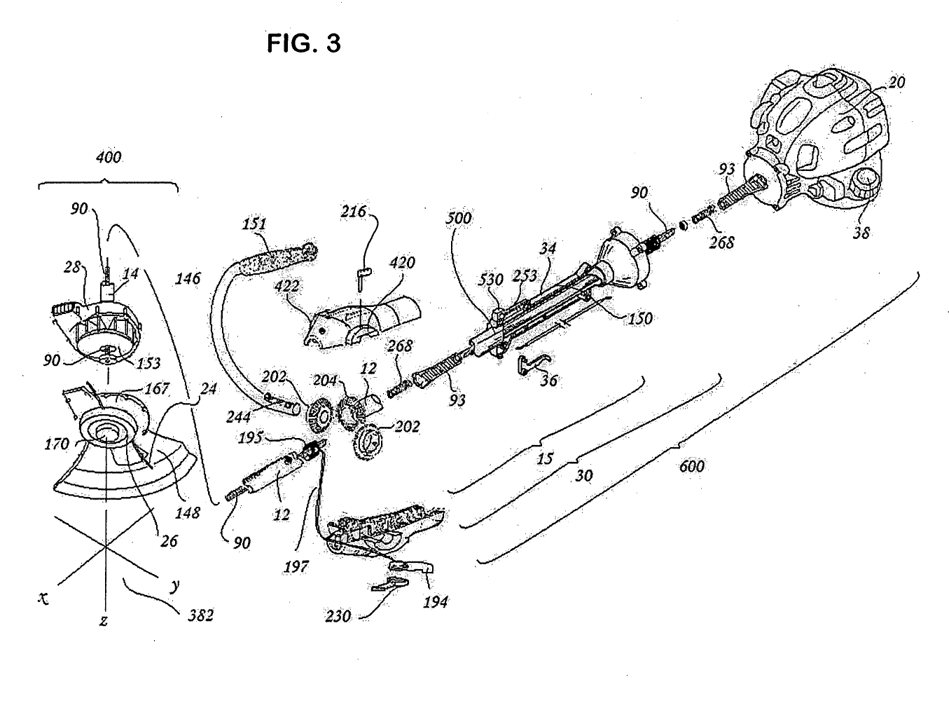

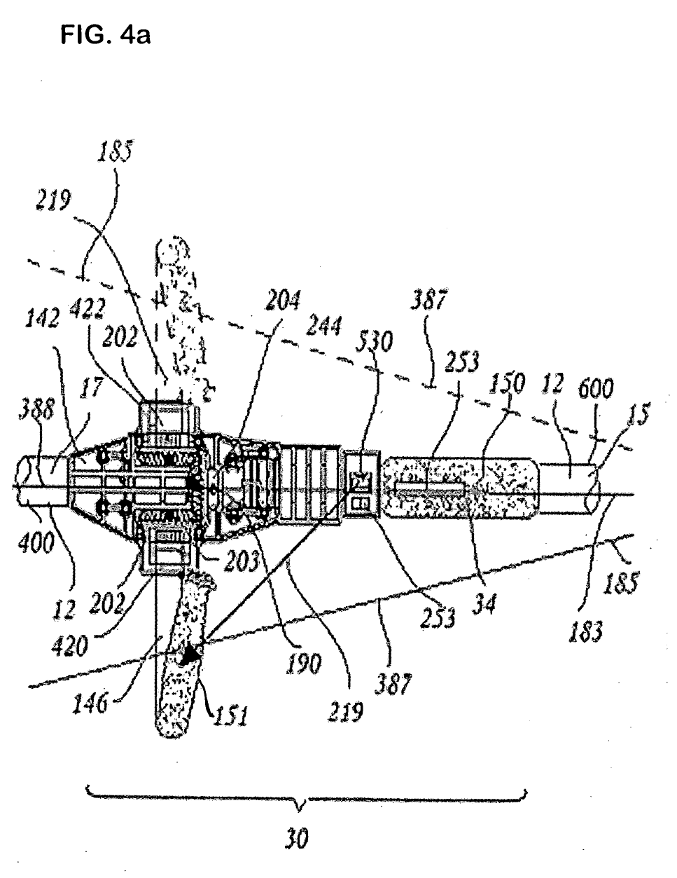

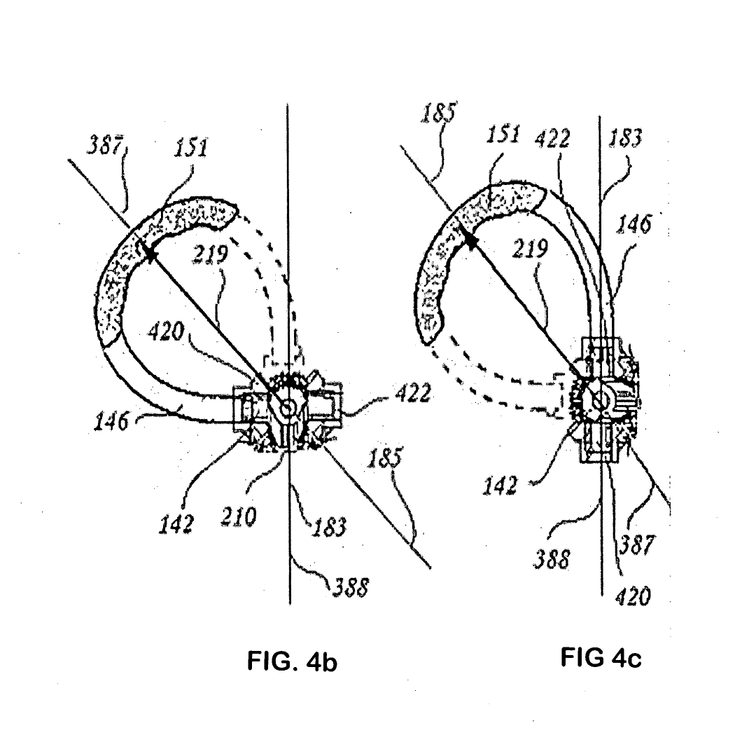

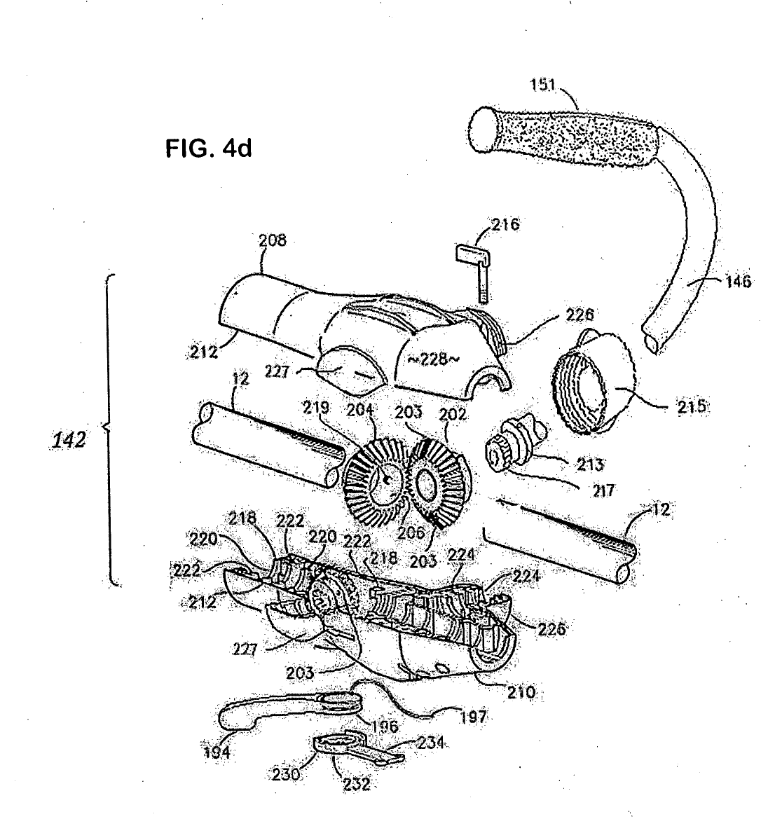

Referring to FIG. 3, the motor 20 can be a gasoline engine of four stroke or two-stroke design, an electric motor, which may be battery operated by either dry, wet or hybrid power, or the like to rotate a drive shaft 90 housed within the boom 12. When the motor 20 requires either a four or two stroke power source the side control handle 146 provides an upward load when gasoline is filled about 1 inch below the gasoline tank cap 38 level and a downward force as the gasoline is consumed to alert an operator when the motor 20 is low on fuel. When the motor 20 requires a battery power source the handlebar 30 upward load is balanced at the fixed point 500 by back up batteries (not shown) for delivery of extended lawn care and without having to loose tool balance. It is important to note that the motor 20 weight is significantly balanced over the fixed point 500 and not behind or in front of an operator where the mass can put significant strain on an operator. The motor assembly 600 includes a drive shaft 90 contained within the boom 12 power segment 15 and rotated by the motor beyond the boom 12 tool segment 17 in one or more rotary directions. The motor 20 consists of an elongated square hole coupling 93 lining up with the drive shaft 90 to translate the motor 20 and drive shaft 90 freely beyond the boom 17 segment and a bushing 133 to a clutch 121. The motor assembly 600 includes a throttle control trigger 36 suspended below the fixed point 500 at all times of operation, a harness clip 530 suspended above the fixed point 500 at all times of operation and one or more motor switches 253 that remain upright when operated. The drive shaft 90 coupled to a shifter 194 is positioned near the fixed point 500 to translate the drive shaft 90 axially from a primary wheel 155 to above a blower debris plate 168 without connecting to the tool assembly 400. The primary wheel 155 is axial fixed to the boom 12 tool end 17 and connects to the drive shaft 90 by the shifter 194 only when needed. The primary wheel 155 and a string trimmer head consist of clam clutch bells 125 that engage the motor 20 at substantially the same operating speed and run at wide open throttle at the same motor 20 operating speed. The shifter 194 can be held in a bracket 230 of the gearbox 142 or on the boom 12 by the like. A cable 197 or the like connects the shifter 194 to an axial drive coupling 195 to translate the motor 20 operation beyond the boom 12 to the blower 28 without connecting the drive shaft 90 to the tool assembly 400 when the motor 20 is operated at idle speed. The shifter 266 is prevented from translating the motor 20 operation to the tool assembly 400 after a throttle control trigger 36 is pulled upward by an index finger according to sound engineering judgment. The motor 20 further provides an operating speed of 8,500 rpm at wide open throttle when the drive shaft 90 is translated between a primary wheel 155 closed plate 153 and a closed blower plate 167. It is important to note that the drive shaft 90 is not assembled to the tool assembly 400 prior to the blower 28 being operated because the drive shaft 90 requires translation during operation for the motor 20 to perform at substantially equal operating speed to minimize tool assembly 400 slippage and maximum fuel efficiency or heat may build up inside the motor assembly 400 and cause a fire. Referring to FIG. 4a-4c, the gearbox 142 upper 208 and lower 210 shell portions connects one or more lateral gears 202 housed within left 226 and right 227 hub portions to a longitudinal gear 204 having an equivalent beveled gear ratio with 32 gear teeth or the like to a pair of addendum cam locks 203. The addendum cam locks 203 are between two gear teeth spaces at opposite ends of the longitudinal gear 204. The longitudinal gear 204 reverses the motor assembly 600 into an upright position in relation to the lateral gears 202 orientating the tool assembly 400 between the wide 183 and narrow 185 operating frameworks. A longitudinal set screw 190 locks the longitudinal gear 204 onto the boom 12 and can adjust to change the height of the side control handle 146. A lateral set screw 216 gear fastener can be tightened to one or more of the lateral gears 202 to lock the handlebar 30 into a working position for long term operation without a tool. The lateral gears 202 consist of one or more bore indents 217 to couple the side control handle 30 to the gearbox 142 by a ring clamp 213. The side control handle provides indent locks 217 that can engage the lateral gears 202 at different angles for adjusting the handlebar 30 height. A threaded hub cap 215 or the like aids with holding the gearbox 142 upper 208 and lower 210 shell portions together and prevents the side control handle from slipping out of socket.

Still referring to FIG. 4a-4d, the handlebar 30 consists of a pair of diagonal incline 151 and decline 150 grips that align with the fixed point 500 and maintains equilibrium at all times without collapsing. The handlebar 30 shares equilibrium with the wide 183 operating framework when the power control handle 34 positions on the longitudinal line of symmetry 388 and the narrow 185 operating framework when the side control handle 146 is on the lateral line of symmetry 387 position. The handlebar 30 tends to balance vibration between both lines of symmetry in the wide 183 and narrow 185 operating framework after the boom 12 is disturbed. The handlebar 30 can be operated when the motor is running without bound within a congruent smaller right isosceles tetrahedron rigid body 414 at the fixed point 500 as shown as shown in FIG. 1a-2b. It is important to note that regular tetrahedron group rotations restrict the base and height measurements of lawn tools to be equal distances which must not be confused with right isosceles tetrahedrons that can fold into orthogonal isometries no matter what differing height and base measurements are required. It is important to further note that 4 longitudinal folds can be connected to the 4 side and 4 diagonal folds of a right isosceles tetrahedron orbital group rotation which shows there is a vertical isometry, but the work is twice as much as a 45 degree diagonal fold and an operators transport view widens significantly.

Still referring to FIG. 4a-4d, the side control handle 146 is of a tubular portion shortened less than a semi-circle with a bend of about 15 degrees longitudinally and about 30 degrees vertical for transposing the incline grip 151. The incline grip 151 comprises a 2.5 inch extension insulating grip 150 to make up for and slack or misalignment of the boom 12. The incline grip 151 combines hand torque with the lateral 202 and longitudinal 204 gears to crank the boom 12 power 15 and tool 17 segments evenly. It is important to note that the boom 12 tool segment 17 can extend to the motor when the boom 12 is straight where the gearbox 244 can also be translated to. Given that the narrow 185 operating framework is about 2.75 inches on average lower than the wide 183 operating framework, the side control handle 146 magnitude 219 can be adjusted for tool assembly 400 group rotations to tile a lawn surface. Hence, a slight grasp adjustment can be made on the incline grip 151 and decline grip 150 to hold the handlebar 30 between 3 inch elevations. The gearbox 142 consists of a handlebar lock 216 which holds the lawn care apparatus 10 in a single frame operation when the motor 20 is operated for a long period of time.

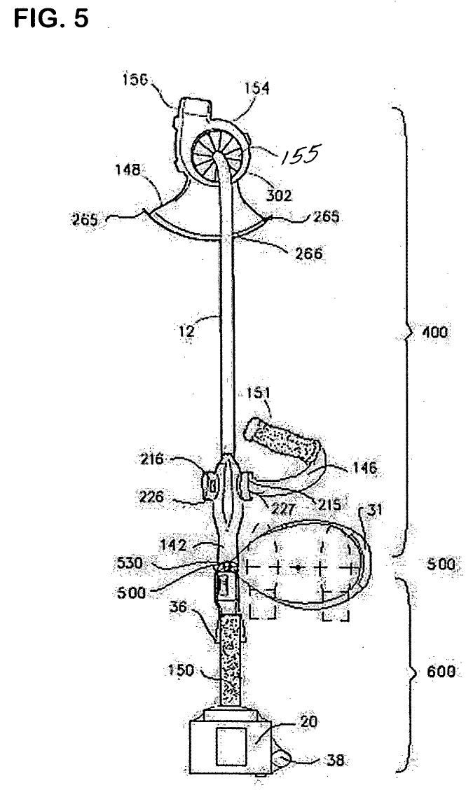

Referring to FIG. 5, the side control handle 146 is held on the right side of the boom 12 by switching the the gearbox left 226 and right 227 hub caps. The boom 12 further provides a harness clip 530 that holds the tool assembly 400 and motor assembly 600 in equilibrium at the fixed point 500. The lawn care apparatus 10 further having the fixed point 500 positioned at least 31 inches from the cuffing guard 148 skid 266 which is ample room for an operator to transport the operable or inoperable string trimmer head 26 (not shown). The cutting guard 148 wings 265 provide about 7 inches more of radial shield protection for the operator.

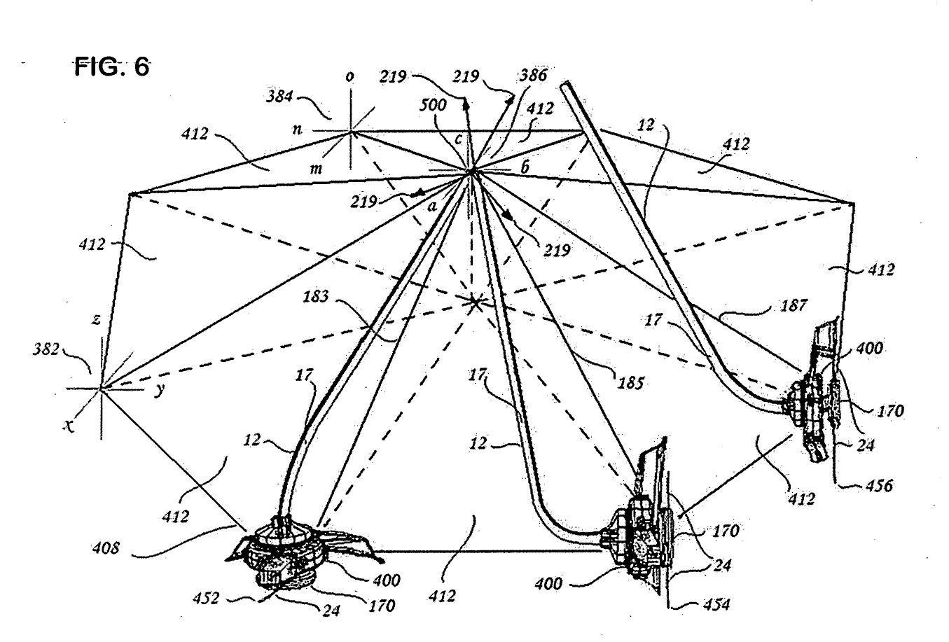

Referring to FIG. 6, the boom 12 tool segment 17 provides a center of rotational symmetry at the fixed point 500 to form 8 orthogonal group lateral folds 408 in the wide 183 and narrow 185 operating frameworks. The first group isometry 187 is preferred because the lateral fold is at least ⅛ times less work than the second isometry 408 folds. Furthermore, the boom 12 can can be folded into one isometry to the left or right by reversing the boom 12 rotation and translation. The first group isometry 187 permits the boom 12 to be orientated between 45 degree lateral widths which provides a 22.5 degree split between the wide 183 and narrow 185 operating frameworks for observing oncoming objects. Since the average stride of the operator is separated by an operating plane measured by about 40 inches and the average height to the fixed point 500 is about 31 inches, the tool assembly 400 can be bound safely away from the fixed point 500 and accessory harness 31.

Still referring to FIG. 4a-FIG. 6, congruently speaking, the rotation vector 416 can translate along the boom 12 from the tool point of origin 170 as a xyz coordinate system 382 to the fixed point 500 as an abc coordinate system 386 followed by the vector 416 to the incline grip 151 origin and followed by the vector magnitude 219 inversing with a mno coordinate system 384 behind and parallel to the boom 12. Therefore, the tool assembly 400 xyz axes of rotation 170 can translate to the fixed point 500 coordinate system abc 386 where the fixed point 500 and incline grip 151 can substitute as a vector magnitude 219 from the nearest working lateral gear 202 to the incline grip 151 center of mass with respect to the incline grip 151 transposing onto the lateral line of symmetry 387 from the longitudinal 388 line of symmetry. An operator or the like can grasp the incline grip 150 with an underhand grip to pull the side control handle 146 opposite of the tool assembly for safekeeping between the wide 183 and narrow 185 operating frameworks and onto a lateral 387 and longitudinal 388 lines of symmetry at all times.

Still referring to FIG. 4a-FIG. 6, in order to determine that a line of symmetry exists to hold the tool assembly 400 wide 183 and narrow 185 operating frameworks in balance, the three coordinates of a rigid body must fold. One way to fold 3 dimensional rigid bodies is to substitute the 3 orthogonal coordinate frames with 3 frames of reference to see if the folded edges tile the plane. Since the goal for a wide 183 and narrow 185 operating framework is a 90° degree fold in reference to a lawn surface whereby a z axis of a right isosceles tetrahedron can fold forward into 260°/90°=4 longitudinal group rotations and the x-axis and y-axis can fold laterally into 360°/45°=8 lateral group rotations the symmetry is satisfied. The z-axis 4 longitudinal group rotations are primarily for rolling tools in a vertical fold which is more ideal for tree trimming, hoe digging and the like. Hence, 1 of 4 vertical folds remains twice the work to orientate compared to 1 of 8 lateral folds, but vertical 90° degree translations are easier to grasp when more balanced over the fixed point 500 which should limit the invention to a lateral isometry. When the large right isosceles tetrahedron rigid bodies are folded laterally, a rotation vector is positioned at the tool assembly 400 reference point 170 to complete 1 of 8 orthogonal group rotations between the wide 183 and narrow 185 operating frameworks. A fold matrix is given by using cosine and sine substitution to form the 3×3 matrix multiplier

$$( x , y , z ) * \begin{matrix}( cy & 0 & - sy ) \\ ( 2 s \hat{} 2 ycy & 1 - s \hat{} 2 y & 2 c \hat{} 2 ysy ) \\ ( sy - 2 s 3 y & - 2 sycy & cy - 2 s \hat{} 2 ycy )\end{matrix} = ( {x}^{*} , {y}^{*} , {z}^{*} )$$

where the z=0 rotation matrix represents the tool assembly translation on a lawn route, x=45 is the lateral fold drop of a right isosceles tetrahedron and 2y is the lateral diagonal fold of a right isosceles tetrahedron and the (x, y, z) point of reference 452 is a vector representing the radius orientation of rotating string. The diagonal fold can transform onto the x axis by x=2y times to preserve a line of symmetry on the boom 12. Furthermore, an operator should expect to find the tangential tool assembly 400 orientated diagonal, that is, parallel to the boom 12 in odd numbered folds because the x and y coordinates share the same 45° degree odd numbered transpose. For example, the initial reference point (8.26, 2, 0) 452 was measured from the string trimmer head origin 170 to the string line filament end point 452 to rotate the vector reference point 452 congruently with the boom 12 rotation vector 219 onto one orthogonal isometry 454 from the following data:

$$( 8.26 , 2 , 0 ) 452 * \begin{matrix}( .707 & 0 & - .707 ) \\ ( .707 & 0 & .707 ) \\ ( 0 & - 1 & 0 )\end{matrix} 219 = ( 7.25 , 0 , - 4.43 ) 454$$

Next, a 180° degree x-axis rotation and a 90 degree 3×3 y-z axis addition is rotated with the same reference point (8.26, 2, 0) 452 and transformed into a second orthogonal group rotation 456 from the following data:

$$( 8.26 , 2 , 0 ) 452 * \begin{matrix}( 0 & 0 & - 1 ) \\ ( 0 & - 1 & 0 ) \\ ( - 1 & 0 & 0 )\end{matrix} 219 = ( 0 , 2 , - 8.26 ) 456$$

Finally, a 720° degree x-axis rotation and a 360° degree 3×3 y-z axis addition is rotated with the same reference point (8.26, 2, 0) 452 and revolved onto itself after 8 group rotations from the following data:

$$( 8.26 , 2 , 0 ) 452 * \begin{matrix}( 1 & 0 & 0 ) \\ ( 0 & 1 & 0 ) \\ ( 0 & 0 & 1 )\end{matrix} 219 = ( 8.26 , 2 , 0 ) 452$$

A symmetrical pattern is shows the tool assembly orbits into 8 group rotations where 1 lateral group rotation provides a path of least resistance. Accordingly, second group rotations are more work and expose cutting tools to the operator as shown by the second group reference point (0, 2, −8.26) 452 with the shield guard flipped upside down directly opposite of a lawn surface and more energy is exerted to perform a series of orthogonal rotations. Hence, a single group rotation bound within right isosceles tetrahedron rigid bodies locks the handlebar 30 cams 203 into wide 183 and narrow 185 operating frameworks without the need of loosening clamps or screws and the equilibrium appears to lower potential risk of lawn care injury.

Still referring to FIG. 1-FIG. 6, having the handlebar held in equilibrium at the fixed point 500 along with controlling lateral and longitudinal vibration at the boom 12 line of symmetry tends to distribute vibration at the fixed point 500 evenly, thereby balancing the stresses. Lateral and longitudinal vibration of the boom 12 feeding back and forth to the handlebar 30 will vary widely, based on how hard the lawn surface is and obliquity. Oblique lawn care tends to add energy into lateral oscillations, but also causes the tangential tool assembly 400 to be sideward with flawed 90° degree lawn care handles which forces operators to hold something on the line of symmetry. This means a slanted narrow 183 operating framework of the tool assembly 400 will not only build up more vibration, but much higher resistance may cause sensitive rotating string 24 or rotating rigid blades to a peak temperature of seizing. In the preferred embodiment, the rotating string 24 ahead of the cutting tool origin 170 compared to repeatedly cutting and tilling through hard lawn surfaces behind the cutting tool origin 170 serves to further reduce lawn tool vibration. When the wide 183 operating framework is used, tilting the side control handle 146 slightly to the left is less effort with the incline grip 151 orientated to the side of the boom 12 which tends to reduce stress from vibration and forces debris low to the ground and forward from the operator. In order to further reduce vibration, the handlebar 30 consists of a series of dynamic reducers 222 overlapping a series of boom 12 dynamic reducers 222.

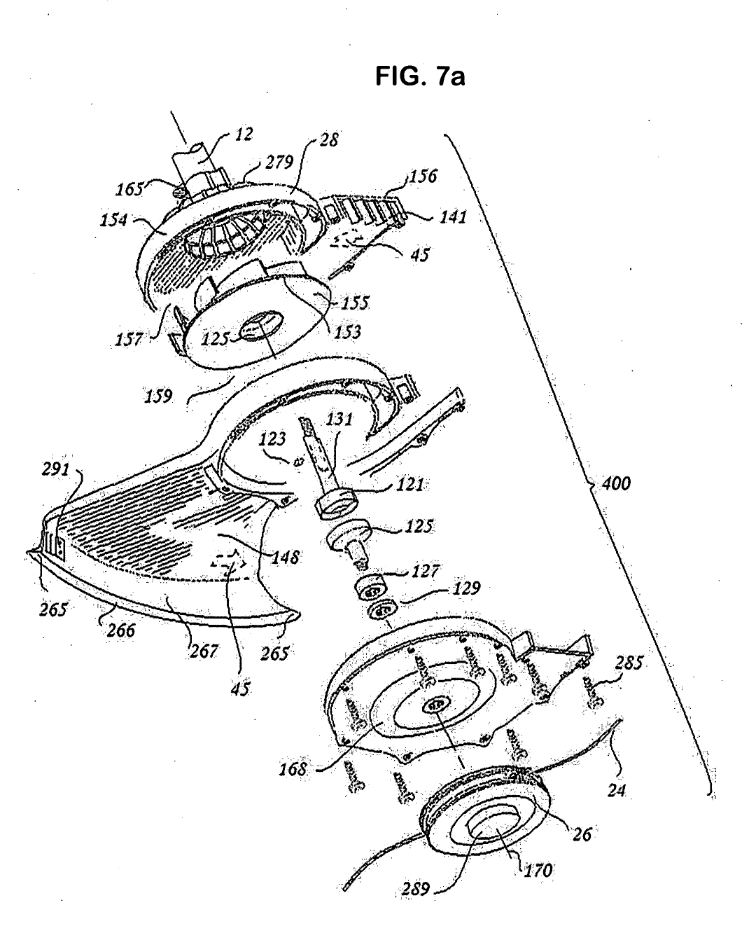

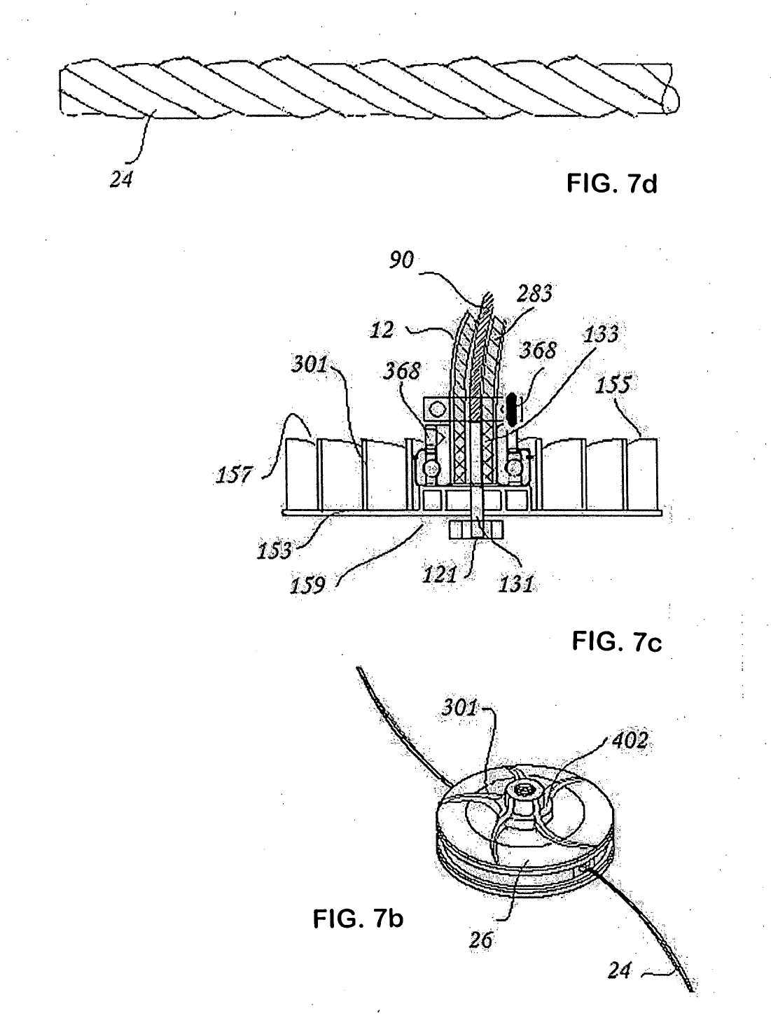

Referring to FIG. 7a-7d, the preferred embodiment having a blower 28 with a blower housing 154 mounted by a button clamp 165 above the boom 12 typically containing a primary wheel 167 with an open airflow section 157 from a crowned open air inlet 279 to beyond an open oblong nozzle 156. The blower 28 further facilitated by a closed debris scroll section 159 from a closed primary wheel plate 153 without notches to a closed blower plate 168 without a hub cavity. The closed blower 168 plate and the closed primary wheel 153 plates face opposite of the open airflow section 157 towards the string trimmer head 26 to prevent debris and heat from building up inside the blower 28. The open scroll section 157 consists of an open flue 281 facing opposite of the cutting tool origin 170 to provide the blower 28 with substantially clean ambient air at all times. The oblong nozzle 156 provides an air discharge arrow 45, as shown in FIG. 6, to facilitate diagonal or forward orientation of the blower 28 operation. The primary wheel 167 is made silent when the blower 28 is not in use and can be removed from the blower 28 for exclusive lawn trimming. It should be noted that closing the primary wheel plate 153 adds less weight to the tool assembly 400 compared to closing off the air inlet 161 or oblong nozzle 156 which may further cause plastic to melt by pressure and heat build up. The primary wheel 167 consists of 9 odd numbered air vanes with altered wave frequencies to blend and reduce noise levels. The primary wheel 155 mounts onto the boom 12 by a flange bearing with the closed primary wheel plate 153 aligned tangential at the tool mount end 14 to exchange downward cooler gases with upward hotter gases at all times within the open scroll section 157 and to prevent debris and air pressure from entering within the blower 28 from the closed scroll section 157. The oblong nozzle 156 having a blower housing 154 with about 8 outer wall screw fasteners 285 to connect a cutting tool 287 plate and cutting guard 148 or blower plate 168 to the tool assembly 400. The oblong nozzle having a guard 141 facing the lawn surface measuring about 2.5 inches by about 1 inch in width. The blower housing 154 mounts to the closed blower plate 168 which mounts tangential to the cutting guard 148 and the string trimmer head 26 to facilitate orthogonal symmetry between the wide 183 and the narrow 185 operating frameworks.

Still referring to FIG. 7a-7d, the string trimmer head 26 consists of a detachable inner spool and outer segments of rotating string 24 filaments to cut vegetation. The string trimmer head 26 outer casing consists of a molded secondary wheel 402 at an apex to clear debris away from between the tool assembly 400 and cool sensitive rotating string 24 at the same time. It is important to note that hub cavities positioned at the string trimmer head 26 apex combined with a 150 mph or more rotating string trimmer head and exposed impeller may cause debris to build in the tool assembly 400 which in turn could cause the rotating string 24 to seize or melt, especially if the rotating string 24 is twisted or braided. The secondary wheel 402 permits the motor 20 to maintain about 8,500 rpm at wide open throttle. The secondary wheel 402 further consists of 5 odd numbered air vanes having altered wave frequencies to clear debris and cool off the tool assembly 400. In an alternative embodiment of the lawn care apparatus 10, the primary wheel 155 and clutch 121 can be removed from the tool assemble to provide a standard string trimmer head and cutting guard.

Still referring to FIG. 7a-7d, the cutting guard 148 consists of a 70 degree wall 267 radius with 10° degree wing 265 radian flare outs and a skid 266 that glides over a lawn surface to gain better balance and protect the tool assembly 400. In addition, the wings 265 are guides for preventing overhanging objects from damage when lining up the tool assembly vertically near landscape beds. The cutting guard 148 wall 267 provides a triple bladed cutter 291 to keep up with advances in rotating string 24 material. The string trimmer head 26 further capable of axial translation at the tangential tool assembly 400 point of origin 170 with a bump and feed 289 head or the like. When the narrow 183 and wide 185 operating frameworks consist of 1 isometry the cutting guard 148 weight can be minimized with respect to aligning the cutting guard 148 with a lawn edge because the boom 12 maintains the same angle to a lawn surface when rotated. Accordingly, the boom 12 provides about the same 30 angle for trimming and edging lawns which permits the cutting guard 148 to provide a mirror reflection wall on both sides of the boom 12 as a shield of protection from flying debris. The cutting guard 148 provides a cutting arrow 45 to show the orientation of the trimming operation. It should be noted that a second group rotation makes it difficult to cover exposed string line when a cutting section in front of an operator transforms to a face down position. It should be further noted that combining weight of a string trimming head with a blower to perform dissimilar interior and exterior operations or paths creates more work and fatigue for the operator.

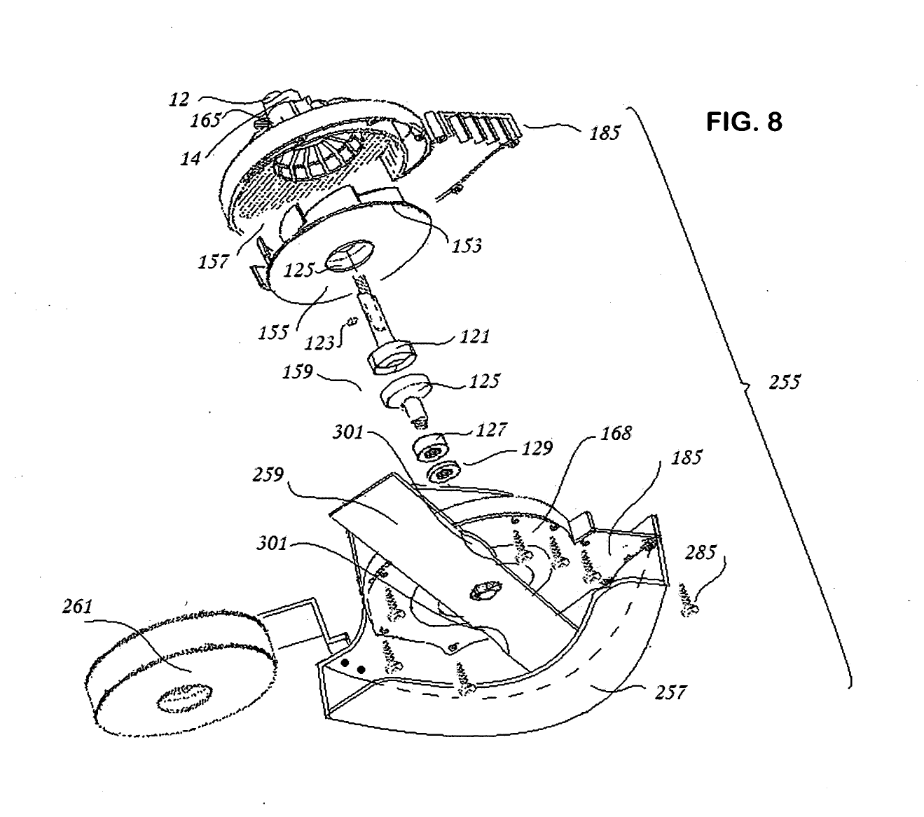

Referring to FIG. 8, an auxiliary edger 255 attachment is mounted to the boom 12 at the boom 12 lateral tool end 14 by the indent clamp 165 to exclusively operate in the narrow 185 operating framework. The primary wheel 155 remains vertical when the blower 28 is connected to the auxiliary edger 255 without an ability to trim lawns. The oblong nozzle 156 can be made of a different cross-section more suited for diagonal blowing. The auxiliary edger 255 can be made of plastic or metallic blade 259 and guard 257 material. The auxiliary edger 255 provides a pair of air vanes 301 at the inner leading edges of the cutting blade 259 to provide an operable secondary wheel 301 when the primary wheel 155 is made inoperable. An edging cutting guard 257 covers a portion of the cutting blade on three sides to prevent mowing with the cutting blade 259. The roller wheel 261 allows the tool assembly 400 to have a greater downward force on thicker vegetation. It is important to note that many lawns are not trimmed, rather, they are exclusively edged to prevent damage to expensive and mature trees, valuable property or the like. It is further important to note that lawns can produce thick rhizomes which can grow aggressively where there is a need for an auxiliary edger on occasion, but an effective string trimmer head used as an edger can complete most lawn edging about 80% of the time. In an alternative embodiment of the lawn care apparatus 10, the boom 12 tool segment 17 can be straight or bent and can consist of a standard lawn edger that connects directly to the gearbox 142.

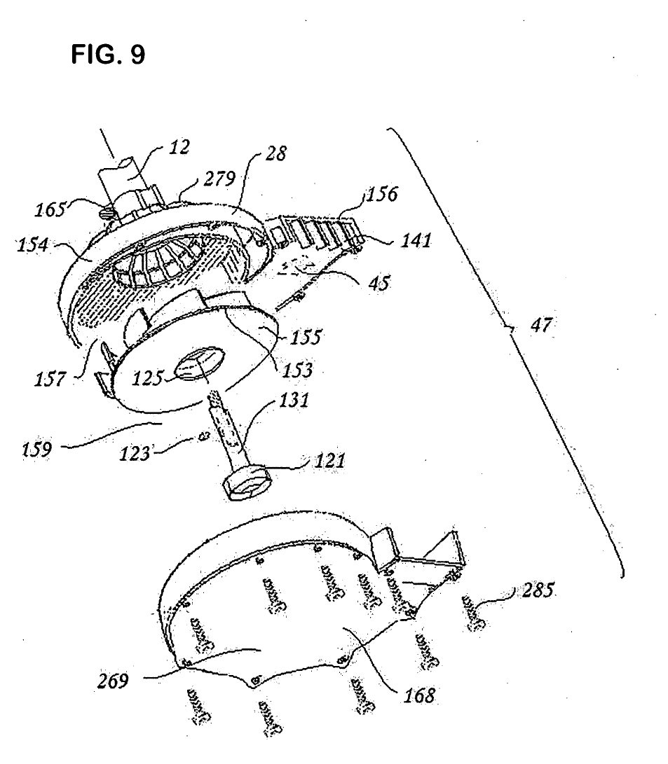

Referring to FIG. 9, an auxiliary blower 47 attachment mounts to the boom 12 with the indent clamp 165 consisting of a flat debris plate 269 to perform lawn care typically when lawns go dormant. The auxiliary blower 47 consists of the oblong nozzle 156 to discharge air in a wide 183 and narrow 185 framework. In an alternative embodiment, the blower 28 and other tool assemblies 400 can consist of a boom 12 tool segment 17 with means to connect directly to the gearbox 142.

Still Referring to FIG. 1-FIG. 9, the blower 28 primary wheel 155 provides 9 odd numbered air vanes with the string trimmer secondary wheel 402 having 5 air vanes 301 of an odd numbered type, followed by a helical drive 90 of an odd numbered type, followed by the primary wheel 155 having air vanes 301 of an odd numbered type, followed by a helical drive shaft 90 of an odd numbered type, followed by a helical boom casing 283 having 3 helical supports of an odd numbered type, followed by a curved shaft boom segment 12, followed by a plurality of concentric gearbox dynamic reducers 222, followed by the diagonal incline 151 and decline 152 foam grips for noise and vibration reduction.

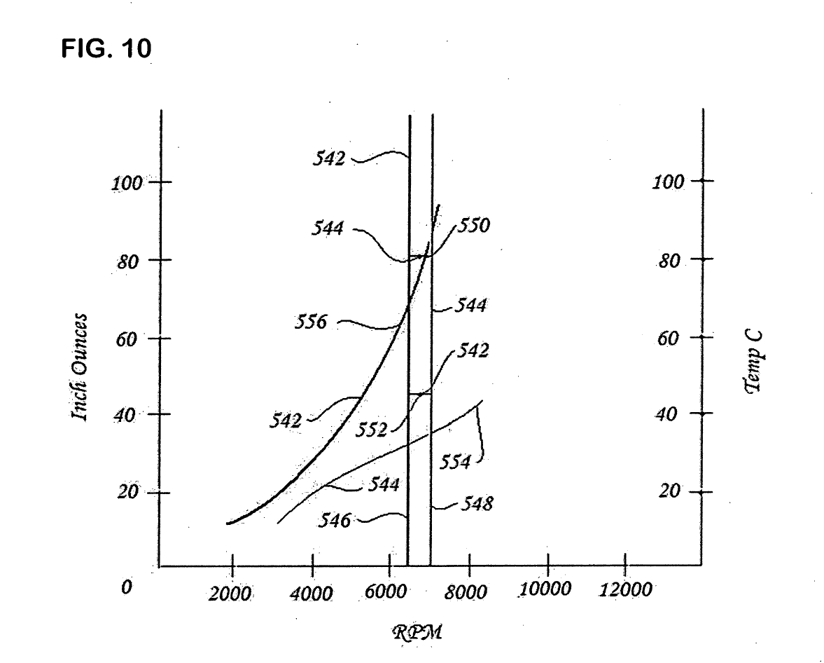

Referring to FIG. 10, a number of tests were performed on operable 17 inch rotating string and an operable 6 inch impeller to determine the performance of patent application Ser. No. 11/585,707. The chart shows rotating string torque stabilizes 556 at wide open throttle motor speed when the blower is made operable 542 compared to the rotating string torque being destabilized 554 when the blower is made inoperable 544. The motor load 548 stabilizes at about 7,000 rpm at wide open throttle motor speed when the blower is made inoperable 544 compared to the motor load destabilized 546 at about 6,500 rpm when the blower is made operable 542. The rotating string temperature being stabilizes at 80 degrees C. at wide open throttle motor speed when the blower is made inoperable 544 compared to the rotating string being destabilized 550 at 120 degrees C. and above when the blower 28 is made operable 542. In conclusion, patent application Ser. No. 11/585,707 failed the motor load, torque and heat operation tests. Hence, the primary wheel 155 is made inoperable 544 when the rotating string 24 is made operable 542 to increase the rotating string 24 torque performance. The secondary wheel 402 is made operable 542 when the rotating string 24 is made operable 542 and the primary wheel is made inoperable 544 to circulate ambient air between the tool assembly 400 and disperse debris away from the blower 28. The rotating string 24 and secondary wheel 402 is made inoperable 544 when the primary wheel 155 is made operable to increase the blower 28 performance and create a draft of ambient air for the tool assembly 400.

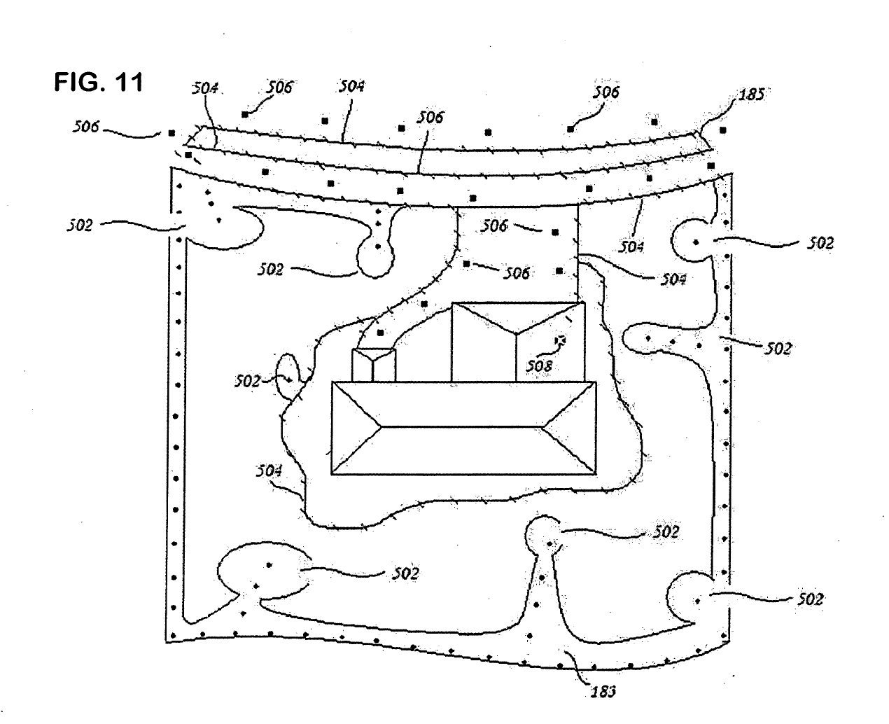

Referring to FIG. 11, the lawn care apparatus 10 typically begins operation from near a base 508 starting point progressing towards a lawn perimeter edging route 504 in a narrow 185 operating framework generally followed by a trimming route 502 in a wide 183 operating framework generally coinciding alongside the edging route 502 and a blower route 506 that can be orientated in the wide 183 operating framework for normal-duty blower work or orientated in the narrow 185 operating framework for heavy-duty blower work corresponding with the edging route 504 for returning alongside a lawn perimeter back to the base 508. Lawn trimming routes 502 progress inside lawn interiors whereas blower routes 506 progress outside of dissimilar lawn interiors to generally return lawn clippings and debris back into lawns. Linking the lawn trimming route 502 with the convenient lawn edging route 504 and the edging route 504 to the corresponding blower route 506 provides a quick 3 step lawn care method with a nicely balanced lawn care apparatus 10.

An efficient lawn care process that holds the lawn care apparatus in symmetry and in equilibrium between the wide 183 and narrow 185 operating frameworks should help improve the lawn care steps and more energy efficiency.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A combination blower, edger, trimmer and method for tending vegetation, comprising:
a motor assembly including a motor, a motor housing, a power control handle, one or more power switches and a throttle control trigger;
the motor assembly held upright behind an operator on a boom from a fixed point proximal end to the motor;
a tool assembly including a cutting tool facilitated by a cutting guard mounted tangential to a blower;
the blower mounted to the boom at a tool distal end;
the cutting tool including a string trimmer head having a secondary wheel without a hub facing the blower;
the secondary wheel having an odd numbered air frequencies;
the tool assembly by the boom from the fixed point to the blower;
the blower including an oblong nozzle open to ambient air at all times and a primary wheel with a base plate open to ambient air on a flue side and shielded on the opposite side to cutting tool clippings;
the blower having an open airflow section facing an air inlet and air outlet and a closed airflow section facing the cutting tool;
a drive shaft contained within the boom and extending from the motor assembly to beyond the boom between the primary and secondary wheel plates;
the drive shaft held in equilibrium at a fixed point;
the drive shaft having means for translating axially between the impeller plate and cutting plate by a shifter mounted near the fixed point when the motor is operated at idle speed;
the drive shaft having means for rotating axially the cutting tool or the impeller with respect to the motor operating speed being substantially equal at wide open throttle;
the primary wheel having an odd numbered air frequencies;
the blower being operable alongside lawn perimeter edging return routes;
the cutting tool including a string trimmer head having a detachable spool string line filaments;
a handlebar mounted axial to the fixed point;
the handlebar balanced at the fixed point;
the handlebar having a gearbox mounted longitudinally to the boom;
the gearbox having a left and right lateral hub;
the left hub having a clamp preventing the handlebar diagonal grips from being pulled towards the operator;
the handlebar having the power control handle mounted longitudinal to the axis of the boom behind the fixed point;
the handlebar having a side control handle mounted laterally to the axis of the boom within a gearbox hub in front of the fixed point;
the side control handle coupled to a beveled gear;
the side control handle having means for reversing the axial rotation of the power control handle at the fixed point;
the side control handle having means for reversing the throttle control trigger at the fixed point;
the side control handle having an incline grip for lawn trimming or normal blowing of vegetation;
the incline grip having means for being transposed onto itself;
the incline and decline grips aligning diagonally on either side of the fixed point;
the incline grip aligning with the axis of the boom in a narrow operating framework;
the decline grip aligning with the axis of the boom in a wide operating framework;
the gearbox hub having means for locking the side control handle and power control handle from rotation;
the side control handle being lockable in the gearbox in a plurality of positions to adjust the height of the side control handle;
the handlebar being lockable in a wide and a narrow operating framework;
the cutting guard arranged to protect an operator in the narrow operating framework when lawn edging;
the cutting guard also arranged to protect an operator in the wide operating framework lawn trimming;
the cutting guard having a skid.

2. (canceled)

3. A combination blower, edger and trimmer apparatus for tending vegetation, comprising:
a motor assembly including a motor, a motor housing, and a power control handle;
an elongated boom having an arcuate distal portion wherein a distal end thereof is oriented substantially orthogonal to a longitudinal axis of the boom;
the motor assembly generally held upright on a proximal end of the boom and being positioned behind an operator when the boom is held at a fixed point proximate to the proximal end of the motor;
a tool assembly including a cutting tool and a cutting guard mounted tangentially to a blower, the blower including an air discharge nozzle;
the blower being mounted to a distal end of the boom with the tool assembly;
the cutting tool including a string trimmer head;
a drive shaft generally coextensive within the boom and extending from the motor assembly to beyond the distal end of the boom at the blower;
the drive shaft being selectively translatable axially within the boom between an impeller plate and cutting plate by a shifter mounted on the boom when the motor is being operated at idle speed;
the drive shaft selectively rotating the cutting tool or the impeller when the motor is being operated at wide open throttle;
a handlebar mounted over the boom between the motor assembly and the fixed point, the handlebar including a gearbox mounted longitudinally to the boom and adjacent to the fixed point;
the handlebar having a side control handle mounted within the gearbox and extending laterally from the boom, the side control handle selectively reversing the axial rotation of the power control handle in the gearbox, the side control handle selectively reversing the position of a throttle control trigger located at the fixed point;
the side control handle also having an incline and a decline grip for lawn trimming or normal blowing of vegetation;
the incline and decline grips being aligned diagonally between the fixed point;
the gearbox hub having a lock which selectively prevents the side control handle and power control handle from rotation;
a cutting guard having a radian surface and a flared surface which protects an operator when said apparatus is configured for use in lawn edging or lawn trimming.
